(19) United States
(12) Patent Application Publication
(10) Pub. No.: US 2016/0162837 A1
(43) Pub. Date: Jun. 9, 2016

(54) COLLABORATION PATTERN CREATION BY CROWDSOURCING PARTICIPANTS

(71) Applicant: CA, Inc., New York, NY (US)

(72) Inventors: Victor Muntés Mulero, Barcelona (ES); Marc Solé Simo, Barcelona (ES)

(21) Appl. No.: 14/561,522

(22) Filed: Dec. 5, 2014

(51) Int. Cl. G06Q 10/10

(52) U.S. Cl. CPC G06Q 10/103; G06Q 50/01

(57) ABSTRACT

A collaboration pattern is created by crowdsourcing participants by publishing requirements for a crowdsourcing project that includes a crowdsourcing task to the crowdsourcing participants, receiving candidate collaboration patterns for the crowdsourcing task from the crowdsourcing participants, selecting one of the candidate collaboration patterns, and executing the crowdsourcing project using the one of the candidate collaboration patterns. Related methods, systems and computer program products are provided.

### BACKGROUND

Significant increases in the use of sophisticated systems have enabled world-wide collaboration through home PCs and, more recently, through ubiquitous hand-held devices. The purposes are as numerous as they are varied, and may include content sharing, whether through blogs or many well-known peer-to-peer (P2P) applications. For example, collaborative computation, starting from the early SETI@home project (setiathome.berkeley.edu) was one of the early large-scale grid computing instances.

People are gaining awareness of the power of collaborating through the network, including, for example, social and/or political collaborations. For example, recent instances have occurred where people organized themselves using digital platforms. As the crowd may become more aware of its power, a next natural step may be to enhance the tools and modalities for collaborative computing. Powerful devices, like smartphones and tablets, are able to carry out an impressive amount and array of computation. P2P computing has been shown to be feasible and efficient. For example, services such as Skype, have shown that the model may be valid and may challenge serious cloud-based competitors, such as Google Voice.

By virtue of machines being connected, people may also be “connected” to the network combining their computing and thinking capacity. Trends may be indicating that this model may gain the ability to complement and/or substitute cloud computing by connecting people and machines in a single network. Currently, many people are asynchronously analyzing, synthesizing, providing opinion and labeling and transcribing data that can be automatically mined, indexed and even learned. In this regard, there may be little effective difference between crowdsourcing and classical computing in that the “crowd” is working online, taking digital data as input, and yielding digital data as output. The main difference is that human brain-guided computation is able to perform tasks that computers can hardly do, at overwhelming speeds. Tagging a picture or a video based on their content or answering questions in natural language, are just a couple of examples.

The term crowdsourcing may refer to the increasing practice of outsourcing tasks to a network as an open call over a variety of users. Crowdsourcing may have evolved to exploit the work potential of a large crowd of people remotely connected through a network. For instance, recent efforts have studied different typologies and uses of crowdsourcing and have proposed a possible taxonomy. The suggested taxonomy has categorized crowdsourcing depending on different methodologies and processes divided according to several dimensions that are shown to impact on the behavior of workers within the crowd, and the tasks that can be outsourced to the crowd.

As this idea increases in terms of popularity, several general purpose crowdsourcing platforms have appeared in the last few years. For instance, Amazon Mechanical Turk (mturk.com) is a crowdsourcing marketplace that enables companies or individuals to utilize the human intelligence to perform tasks that may be difficult for computers. The requestors post tasks known as Human Intelligence Tasks (HITs) that can be viewed by workers. Other examples like CrowdFlower (crowdflower.com) or ClickWorker (clickworker.com), may extend Mechanical Turk capabilities offering a variety of crowdsourcing services. They may improve quality by using gold standard units, redundant reviews of each data unit, etc. Their workflow management system divides complex tasks into smaller units and distributes them among the crowd based on the profile of individuals.

Quality control may be a key point in crowdsourcing and may change depending on the nature of the task being crowdsourced. For instance, on the one hand, some studies show how the results obtained from the crowd are more inaccurate compared to laboratory participants. In contrast, other work, such as CrowdSearch, a system to search images on mobile phones using the crowd, may show that workers are able to achieve over 95% precision.

Other lines of research study the effect that different reward systems have on quality. For instance, financial incentives may encourage quality. Some platforms like Kaggle (kaggle.com) may guarantee quality by two combined strategies: an open competition that may derive the best predictive model for a given set of data combined with an economical incentive for the winner.

Crowdsourcing markets may be traditionally used for simple and independent tasks. For example, labeling an image or finding relevance between search results. A framework that enables solving complex and interdependent tasks using crowdsourcing markets has also been presented and may use an approach similar to MapReduce for breaking down a complex problem into a sequence of simpler subtasks. The subtasks may be solved in parallel by the crowd and the results may be combined to form a final solution.

However, crowdsourcing systems to date have generally been designed ad-hoc and thus may duplicate functionalities thus requiring significant resources to produce such systems. Current strategies that rely on third party platform, such as Mechanical Turk, may still require a non-negligible amount of work and may be affected by inherent limitations in the platform. For example, features that are offered may be restricted by characteristics and limitations of such platforms. Additionally, such platforms may be proprietary and thus crowdsourcing frameworks may have no control over possible changes to the interface. As such, framework revisions and/or updates may be necessary to be compatible with such changes. Additionally, since third party platforms may be provided as a paid service, charging, for example, a commission, unexpected and/or undesirable fee changes may be imposed.

One such platform includes Automan, which may strive to seamlessly integrate crowdsourcing tasks into regular Java (or JVM-based derivative, like Scala) code. Technically, Automan may be a library that offers functions to create HITs in MTurk. The type of tasks may be rather limited (like selecting the best option among a set of candidates) and the task information and interaction with a user may be fundamentally textual (no specific/tailored UI for a specific task can be provided). Automan may transparently manage quality aspects such as requiring a given amount of confidence in the result. Until a specified threshold is reached, a Human Intelligence Task (HIT) may be reposted so as to gather more data. This functionality may be hidden from the user in that a function call may just return and the corresponding processing may start concurrently in a new thread. When human results are needed, mechanisms for waiting for such results may be provided. Once available, the results may then be used inside the Java code as if originating from any other data source.

Another example of a platform is Turkomatic, which uses the crowd itself to decide how a complex task has to be split. The main idea is that the initial complex task is described by the user, and then a HIT is created in MTurk that simply demands that the worker answers the following question: “Do you believe that this task can be done as a single HIT?” If the answer is Yes, then the task may be posted as is and the results may then be sent to the requestor. On the other hand, if the worker replies No, the worker is asked to split the task into smaller subtasks and to specify their relation. For example, subtasks may be sequential and/or may be solved concurrently. For each of these subtasks, the process may start again.

As with Automan, the interfaces used in Turkomatic may be primarily textual. As such, no specific/tailored UI for a specific task may be provided. The final result may be that an acyclic graph of tasks is created and executed. Once all the subtasks of a given task are solved, then a new HIT may be created so that a human can merge all the subtasks results to provide a reasonable result for the parent task. Besides allowing the crowd to create this graph, Turkomatic may allow the requestor to provide the graph from the beginning, in various stages of completion ranging from complete to partially specified. However, iterative behavior may not be supported since all the graphs are acyclic.

### BRIEF SUMMARY

It is noted that aspects described with respect to one embodiment may be incorporated in different embodiments although not specifically described relative thereto. That is, all embodiments and/or features of any embodiments can be combined in any way and/or combination. Moreover, other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

Some embodiments of the present inventive concepts are directed to methods that comprise publishing requirements for a crowdsourcing project that comprises a crowdsourcing task to crowdsourcing participants, receiving candidate collaboration patterns for the crowdsourcing task from ones of the crowdsourcing participants, selecting one of the candidate collaboration patterns, and executing the crowdsourcing project using the one of the candidate collaboration patterns to perform the crowdsourcing task.

In some embodiments, the requirements for the crowdsourcing project do not identify a collaboration pattern. Moreover, in some embodiments the receiving includes receiving a candidate collaboration pattern for the crowdsourcing task as a selection from a library of collaboration patterns, as a modification of a collaboration pattern in the library or as a new collaboration pattern that is not based upon a collaboration pattern in the library. The receiving may also include providing access by the crowdsourcing participants to the library of collaboration patterns.

In some embodiments the publishing and the selecting are performed by a collaboration pattern co-creation system in response to input from a requestor of the crowdsourcing project, the receiving is performed by a collaboration pattern editor and the executing is performed by a collaboration pattern execution engine. Moreover, in some embodiments the receiving is repeatedly performed prior to performing the selecting.

Other embodiments further comprise generating effectiveness metrics for the one of the candidate collaboration patterns based on results of the executing the crowdsourcing project using the one of the candidate collaboration patterns. Yet other embodiments may further comprise rewarding a crowdsourcing participant from whom the one of the candidate collaboration patterns was received.

Still other embodiments may further comprise generating effectiveness metrics for the candidate collaboration patterns. The effectiveness metrics may be generated by generating results profiles for the candidate collaboration patterns, generating scores from the results profiles, and ranking the candidate collaboration patterns according to the scores. In some embodiments the results profile is generated from another crowdsourcing project that comprises the candidate collaboration pattern.

Still other embodiments further comprise informing the crowdsourcing participants of the one of the candidate collaboration patterns that was selected. According to other embodiments, the publishing is preceded by identifying a collaboration pattern that is related to the crowdsourcing task, and the publishing comprises publishing the collaboration pattern that is related to the crowdsourcing task along with the requirements for the crowdsourcing project.

Some embodiments of the present inventive concepts include a computer program product that includes a computer readable storage medium having computer readable program code embodied in the medium. The computer code is embodied such that when executed by a processor of a computer system, the computer system is caused to perform operations comprising publishing requirements for a crowdsourcing project that comprises a crowdsourcing task to crowdsourcing participants, receiving candidate collaboration patterns for the crowdsourcing task from the crowdsourcing participants, selecting one of the candidate collaboration patterns, and executing the crowdsourcing project using the one of the candidate collaboration patterns to perform the crowdsourcing task. Other operations according to any of the embodiments described above may also be performed.

Embodiments of the present inventive concepts may also be directed to computer systems that include a processor and a memory coupled to the processor. The memory may include computer readable program code embodied therein that, when executed by the processor, causes the processor to perform functions and operations as disclosed herein.

Embodiments herein include computer program products and systems that may be configured and/or operable to perform operations described herein.

It is noted that aspects of the disclosure described with respect to one embodiment, may be incorporated in a different embodiment although not specifically described relative thereto. That is, all embodiments and/or features of any embodiment can be combined in any way and/or combination. These and other objects and/or aspects of the present invention are explained in detail in the specification set forth below.

### BRIEF DESCRIPTION OF THE DRAWINGS

Aspects of the present disclosure are illustrated by way of example and are not limited by the accompanying figures with like references indicating like elements.

FIG. 1 is a block diagram illustrating devices/modules that may be used according to some embodiments of the present inventive subject matter.

FIG. 2 is a block diagram of a computing system that supports a virtual operating environment according to some embodiments of the present inventive subject matter.

FIG. 3 illustrates a virtual computing environment according to some embodiments of the present inventive subject matter.

FIG. 4 is a block diagram illustrating an example of an action verification unit that may be used to define collaboration patterns for crowdsourcing according some embodiments of the present inventive subject matter.

FIG. 5 is a block diagram illustrating multiple action verification units that may be used in collaboration patterns for complex crowdsourcing tasks according to some embodiments of the present inventive subject matter.

FIG. 6A-6D are block diagram illustrating different collaboration patterns with different complexities for crowdsourcing a text translation from one language to another language according to some embodiments of the present inventive subject matter.

FIG. 7 is a block diagram illustrating different collaboration patterns that may be generated for new types of tasks according to some embodiments of the present inventive subject matter.

FIG. 8 is a block diagram illustrating a use case for using crowdsourcing to write a travel book according to some embodiments of the present inventive subject matter.

FIG. 9 is a flowchart illustrating operations for systems/methods according to some embodiments of the present inventive subject matter.

FIG. 10 is a block diagram illustrating devices/modules that may be used to allow collaboration pattern creation by crowdsourcing participants according to other embodiments of the present inventive subject matter.

FIGS. 11 and 12 are flowcharts of operations that may be performed for collaboration pattern creation and execution according to other embodiments of the present inventive subject matter.

FIG. 13 is a flowchart of operations that may be performed to select one of the candidate collaboration patterns according to other embodiments of the present inventive subject matter.

FIG. 14 is a flowchart of operations that may be performed to select post processing according to other embodiments of the present inventive subject matter.

FIG. 15 illustrates an example of a collaboration pattern.

FIGS. 16-19 are functional diagrams of systems, methods and computer program products according to various embodiments of the present inventive subject matter.

FIG. 20 is a flowchart of preprocessing operations that may be performed according to various embodiments of the present inventive subject matter.

FIGS. 21A-2D are flowcharts illustrating collaboration pattern co-creation according to various embodiments of the present inventive subject matter.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

Collaborative Pattern Execution and Editing for Crowdsourcing Platforms

Various aspects of collaboration pattern execution and editing for crowdsourcing platforms will now be described, according to application Ser. No. 14/097,591, filed Dec. 5, 2013, entitled Collaboration Pattern Execution and Editing for Crowdsourcing Platforms (Attorney Docket 1100-130163/20130163) the disclosure of which is hereby incorporated herein by reference in its entirety as if set forth fully herein, Collaboration Pattern Creation By Crowdsourcing Project Participants will then be described according to various embodiments of the present inventive concepts.

As described in application Ser. No. 14/097,591, the quality of a human asset may be represented by a ranking (or set of different rankings). The actions of the human assets corresponding to systems and methods described herein may affect this ranking and their ranking may further determine how the platform reacts for these human assets and users of the systems and methods.

Additionally, crowdsourcing as used herein may include functions and actions of human assets that provide and/or manage information as well as automated systems and methods. For example, sensors providing a stream of data and/or computational devices may be considered as a special type of crowdsourcing assets that can be used in combination with human assets.

In use and operation, systems and methods herein may provide complete crowdsourcing, reducing and/or eliminating the reliance on third-party platforms, thus reducing constraints corresponding to such platforms.

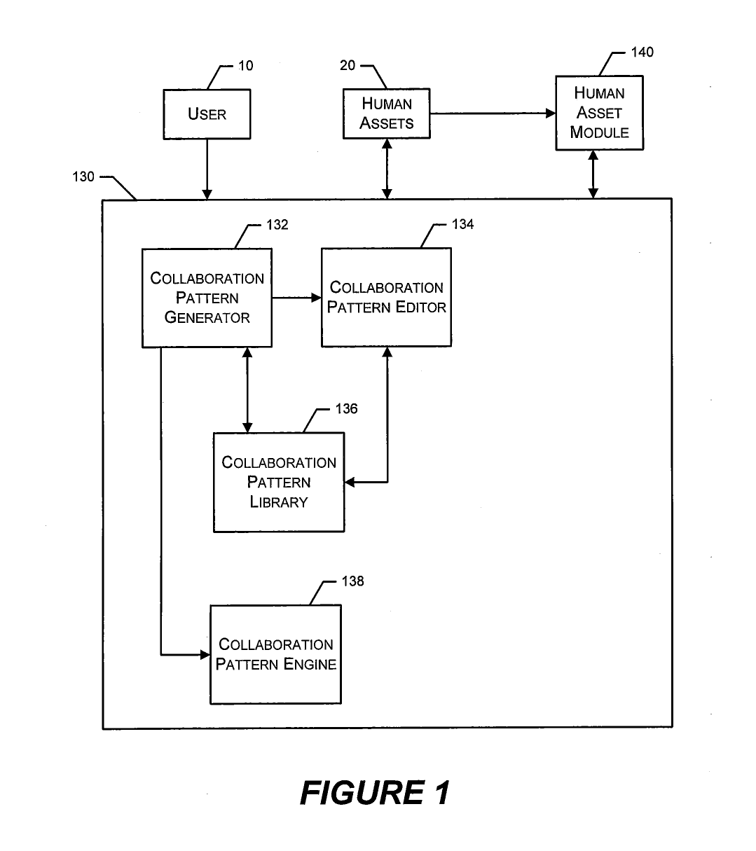

Some embodiments of the inventive concepts include a crowdsourcing execution engine that reacts to the environment to provide an adaptive engine. For example, crowdsourcing as described herein may consider conditional patterns that select different collaboration patterns depending on different scenarios according to a wide range of metrics (time, money, quality, etc.). However, for simple patterns, it might be cumbersome to specify many alternatives. Thus, some embodiments provide that the execution engine monitors all the metrics and, if the pattern designer allows, the execution engine can modify a collaborative pattern on-the-fly to adapt to the conditions. For instance, in a voting pattern that the designer specified to have 50 voters and had to be completed in less than two days, if the deadline is reached before a requisite number of votes, the systems and methods described herein may reduce the number of required voters to proceed or can proceed once the requisite number of votes is reached regardless of the elapsed time. In some embodiments, in an action verification unit that has been defined without any limitation on the number of iterations (like the loops in the patterns of FIG. 1), some limit can be imposed if a non-progress situation is detected. In case the stall is produced by different criteria of workers, then a conversion of the pattern to a voting pattern can be performed to solve the problem.

Another way in which an execution engine described herein may be adaptive may occur when the designer inputs some basic parameters like time, workers, quality, application domain, etc. The execution engine may suggest collaborative patterns that have given the best results in the past under similar domain and conditions. With the passage of time, the system may contain, learn, have more information, and become more accurate in suggesting the right patterns.

Reference is now made to FIG. 1, which is a block diagram illustrating devices/modules that may be used according to some embodiments of the present inventive subject matter. A collaboration pattern module 130 may be configured to receive crowdsourcing project related inputs from a user 10 and provide collaboration pattern definition, generation, modification, execution and/or management. For example, a collaboration pattern module 130 may include a collaboration pattern generator 132 that is configured to generate a collaboration pattern responsive to inputs provided by the user 10. As used herein, the term “collaboration pattern” may be used to refer to patterns of collaboration of different actors to accomplish one or more human intelligence tasks in a crowdsourcing project. Some embodiments provide that the collaboration patterns are general graphs and thus may not be limited to a specific type of graphs, in contrast with, for example, Turkomatic, which appears to be limited to acyclic graphs. Some embodiments provide that the tasks in collaboration patterns disclosed herein are each assigned user interfaces (UIs) to provide more flexibility and detail regarding the types of tasks that can be performed by the human assets 20.

The collaboration pattern generator 132 may receive inputs from the user 10 and generate one or more suggested collaboration patterns that may be stored in a collaboration pattern library 136. In addition to storing collaboration patterns, the collaboration pattern library 136 may store performance data corresponding to different ones of the collaboration patterns including, for example, feedback indicating how well a collaboration pattern has worked in performing different types of crowdsourcing projects. For example, a collaboration pattern that is particularly effective for crowdsourcing localization tasks, such as translating a text from one language to another language, may be less suitable for crowdsourcing works of authorship, such as, for example, travel books.

In some embodiments, the collaboration pattern module 130 may include a collaboration pattern editor 134 that may receive editing inputs that edit the collaboration pattern that corresponds to the crowdsourcing project. The collaboration pattern editor 134 may retrieve collaboration pattern information from and send collaboration information to the collaboration pattern library 136. Tasks that are defined in different elements of collaboration patterns may be performed by human assets 20. The collaboration pattern module 130 may receive and provide human asset data via a human asset module 140, which may generate human asset worker profiles corresponding to human assets. Some embodiments provide that human asset worker profiles may include human asset performance information and one or more human asset specific characteristics. Examples of human asset specific characteristics may include geographic knowledge, language skills/fluency levels, and/or schedule limitations, among others. Human asset performance information may include rankings and/or scores for timeliness, accuracy, and/or quality, among others. The human asset worker profiles may be updated responsive to new human asset performance information and/or human asset specific characteristics.

Some embodiments provide that the collaboration pattern module 130 may include a collaboration pattern engine 138 that is configured to execute and/or manage the execution of a collaboration pattern. Although illustrated herein as the collaboration pattern module 130 including the collaboration pattern generator 132, the collaboration pattern editor 134, the collaboration pattern library 136 and the collaboration pattern engine 138, embodiments are not so limited. For example, any one or more of the described components of the collaboration pattern module may be implemented as separate modules. Additionally, although illustrated as separate from the collaboration pattern module 130, the human asset module 140 may be incorporated and/or integrated into and/or with the collaboration pattern module 130.

In some embodiments, the collaboration pattern module 130 including the collaboration pattern generator 132, the collaboration pattern editor 134, the collaboration pattern library 136, the collaboration pattern engine 138 and the human asset module 140 may include one or more graphical interfaces. In this manner, systems and methods disclosed herein may provide a functional and complete crowdsourcing platform from easy-to-create descriptions.

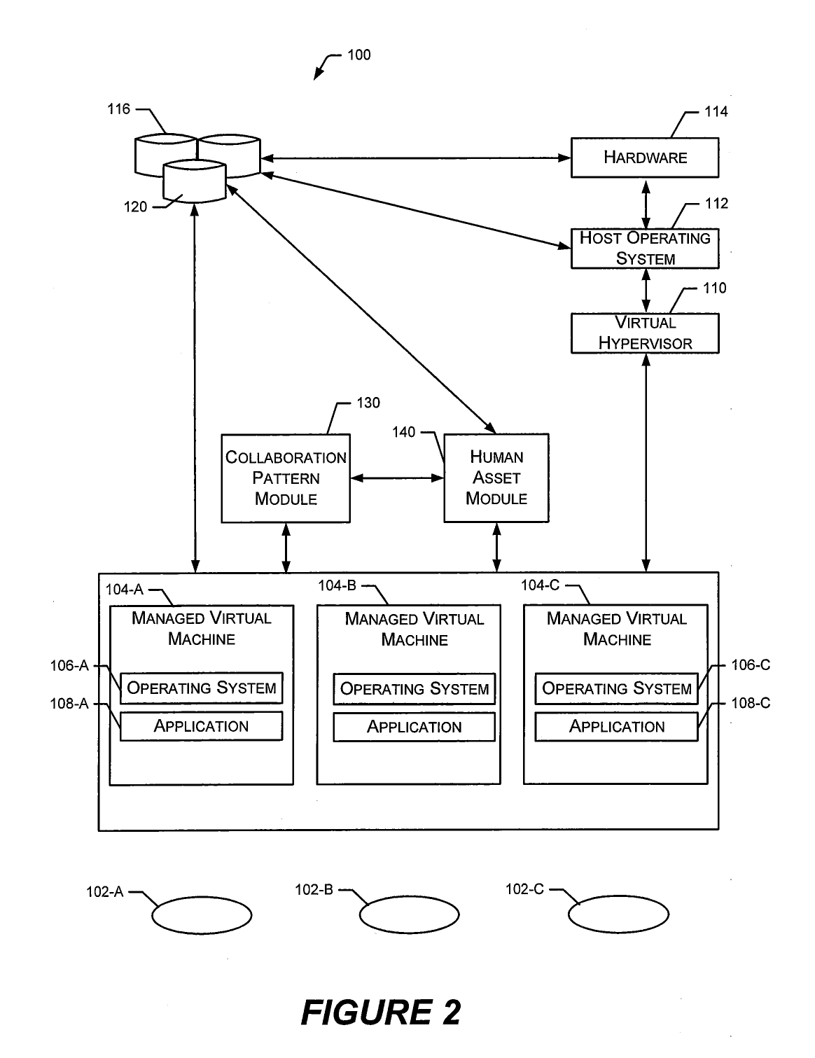

Reference is now made to FIG. 2, which is a block diagram of a computing system that supports a virtual operating environment according to some embodiments of the present inventive subject matter. The computer system 100 generally hosts and manages one or more virtual machines 104 (hereafter managed virtual machine, or managed machine), each of which runs a guest operating system 106 and application 108. The computing needs of users 102 (e.g., humans and/or other virtual/non-virtual machines) drive the functionality of the virtual machines 104. A virtual hypervisor 110 can provide an interface between the virtual machines 104 and a host operating system 112 and allow multiple guest operating systems 106 and associated applications 108 to run concurrently. The host operating system 112 handles the operations of a hardware platform 114 capable of implementing virtual machines 104. A data storage space 116 may be accessed by the host operating system 112 and is connected to the hardware platform 114.

The hardware platform 114 generally refers to any computer system capable of implementing virtual machines 104, which may include, without limitation, a mainframe computer platform, personal computer, mobile computer (e.g., tablet computer), server, wireless communication terminal (e.g., cellular data terminal), or any other appropriate program code processing hardware. The hardware platform 114 may include computer resources such as a processing circuit(s) (e.g., central processing unit, CPU); networking controllers; communication controllers; a display unit; a program and data storage device; memory controllers; input devices (such as a keyboard, a mouse, etc.) and output devices such as printers. The processing circuit(s) is configured to execute computer program code from memory device(s), described below as a computer readable storage medium, to perform at least some of the operations and methods described herein, and may be any conventional processor circuit(s), such as the AMD Athlon™ 64, or Intel® Core™ Duo.

The hardware platform 114 may be further connected to the data storage space 116 through serial and/or parallel connections. The data storage space 116 may be any suitable device capable of storing computer-readable data and program code, and it may include logic in the form of disk drives, random access memory (RAM), or read only memory (ROM), removable media, or any other suitable memory component. According to the illustrated embodiment, the host operating system 112 functionally interconnects the hardware platform 114 and the users 102 and is responsible for the management and coordination of activities and the sharing of the computer resources.

Although some embodiments of the computer system 100 can be configured to operate as a computer server, the computer system 100 is not limited thereto and can be configured to provide other functionality, such as data processing, communications routing, etc.

Besides acting as a host for computing applications that run on the hardware platform 114, the host operating system 112 may operate at the highest priority level in the system 100, executing instructions associated with the hardware platform 114, and it may have exclusive privileged access to the hardware platform 114. The priority and privileged access of hardware resources affords the host operating system 112 exclusive control over resources and instructions, and may preclude interference with the execution of different application programs or the operating system. The host operating system 112 can create an environment for implementing a virtual machine, hosting the “guest” virtual machine. One host operating system 112 is capable of implementing multiple isolated virtual machines simultaneously.

A virtual hypervisor 110 (which may also be known as a virtual machine monitor or VMM) may run on the host operating system 112 and may provide an interface between the virtual machine 104 and the hardware platform 114 through the host operating system 112. The virtual hypervisor 110 virtualizes the computer system resources and facilitates the operation of the virtual machines 104. The hypervisor 110 may provide the illusion of operating at the highest priority level to the guest operating system 106. However, the virtual hypervisor 110 can map the guest operating system's priority level to a priority level lower than the top most priority level. As a result, the virtual hypervisor 110 can intercept the guest operating system 106, and execute instructions that require virtualization assistance. Alternatively, the virtual hypervisor 110 may emulate or actually execute the instructions on behalf of the guest operating system 106. Software steps permitting indirect interaction between the guest operating system 106 and the physical hardware platform 114 can also be performed by the virtual hypervisor 110.

When operating in a virtualized environment, the virtual machines 104 present a virtualized environment to the guest operating systems 106, which in turn provide an operating environment for applications 108 and other software constructs.

Applications 108 that are implemented on the virtual machines 104 may be configured to access one or more data sources in accordance with the functions thereof. As discussed herein by way of example, a data source may be a file, however, the disclosure is not so limited. For example, database applications and/or applications that operate, at least in part, using data sources such as database files, may rely on access to one or more database files to perform the requisite operations. In some embodiments, such access may further include one or more settings that determine or identify a portion, format, location, path, version or other attribute of the file being accessed. For example, an access request corresponding to a database file may include query terms, among others. In some embodiments, an access request corresponding to a database file may be directed to a database 120 that may be included in or provided in addition to the data storage space 116.

In some embodiments, a collaboration pattern module 130 may be configured to receive crowdsourcing project related inputs from a user and provide collaboration pattern definition, generation, modification, execution and/or management. A human asset module 140 may generate human asset worker profiles corresponding to human assets. Some embodiments provide that human asset worker profiles may include human asset performance information and one or more human asset specific characteristics.

Although illustrated as a stand-alone functional block, the collaboration pattern module 130 and/or the human asset module 140 may be a module, function, feature and/or service included in and/or integrated with a service that provides crowdsourcing platforms and/or support.

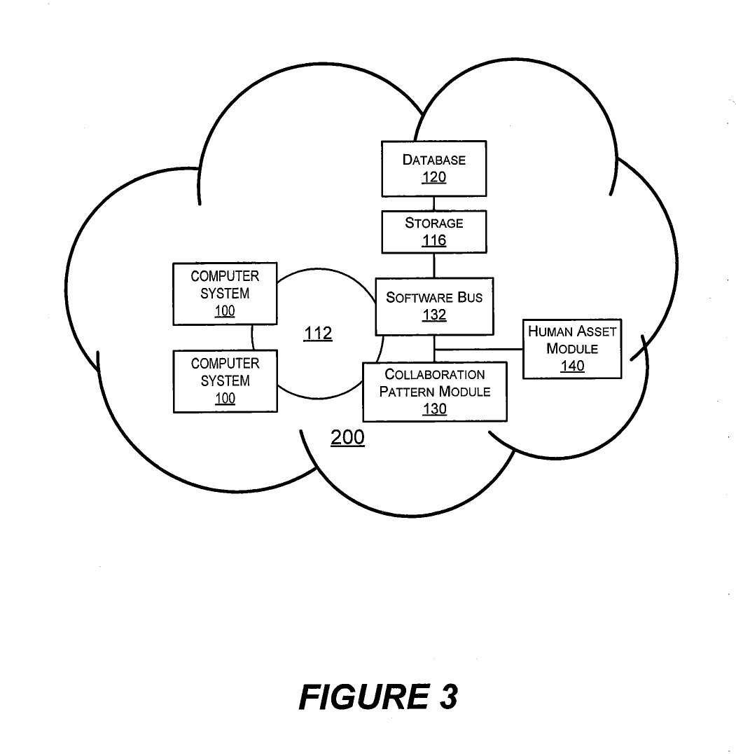

FIG. 3 illustrates a virtual computing environment according to some embodiments of the present inventive subject matter. A virtual computing environment 200 (referred to generally as cloud 200) may include one or more computer systems 100 (referred to as server systems) that may include one or more electronic computing devices operable to receive, transmit, process, and store data. For example, the servers in the cloud 200 may include one or more general-purpose personal computers, workstations, server computers, server pools, or any other suitable devices. In certain embodiments, the cloud 200 may include a web server. In short, the cloud 200 may include any suitable combination of software, firmware, and hardware.

The plurality of server systems 100 may be communicatively coupled via a network 112. The network 112 facilitates wireless and/or wireline communication, and may communicate using, for example, IP packets, Frame Relay frames, Asynchronous Transfer Mode (ATM) cells, voice, video, data, and other suitable information between network addresses. The network 112 may include one or more local area networks (LANs), radio access networks (RANs), metropolitan area networks (MANs), wide area networks (WANs), all or a portion of the global computer network known as the Internet, and/or any other communication system or systems at one or more locations. Although referred to herein as “server systems”, it will be appreciated that any suitable computing device may be used. A network address may include an alphabetic and/or numerical label assigned to a device in a network. For example, a network address may include an IP address, an IPX address, a network layer address, a MAC address, an X.25/X.21 address, and/or a mount point in a distributed file system, among others.

While FIG. 3 illustrates a physical configuration of servers within a cloud 200, a computer system 100 may include a logical grouping of virtual machines 104 within a virtualization environment in the cloud 200. Although not illustrated herein, the virtual machines 104 in the cloud can be organized and managed in clusters, which may also referred to herein as “grids”. A virtualization environment in the cloud 200 may be managed by a single hypervisor 110, or a set of hypervisors 110.

Virtual machines can be deployed in particular virtualization environments and organized to increase the efficiency of operating and/or managing a virtual computing environment. For example, virtual machines may be grouped into clusters in order to provide load balancing across multiple servers.

A collaboration pattern module 130 as discussed above regarding FIG. 2 may receive crowdsourcing project related inputs from a user and provide collaboration pattern definition, generation, modification, execution and/or management operations. A human asset module 140 as discussed above regarding FIG. 2 may generate human asset worker profiles corresponding to human assets. The collaboration pattern module 130 and/or the human asset module 140 may be included in and/or provided by one or more of the virtual machines 104 in the cloud 200.

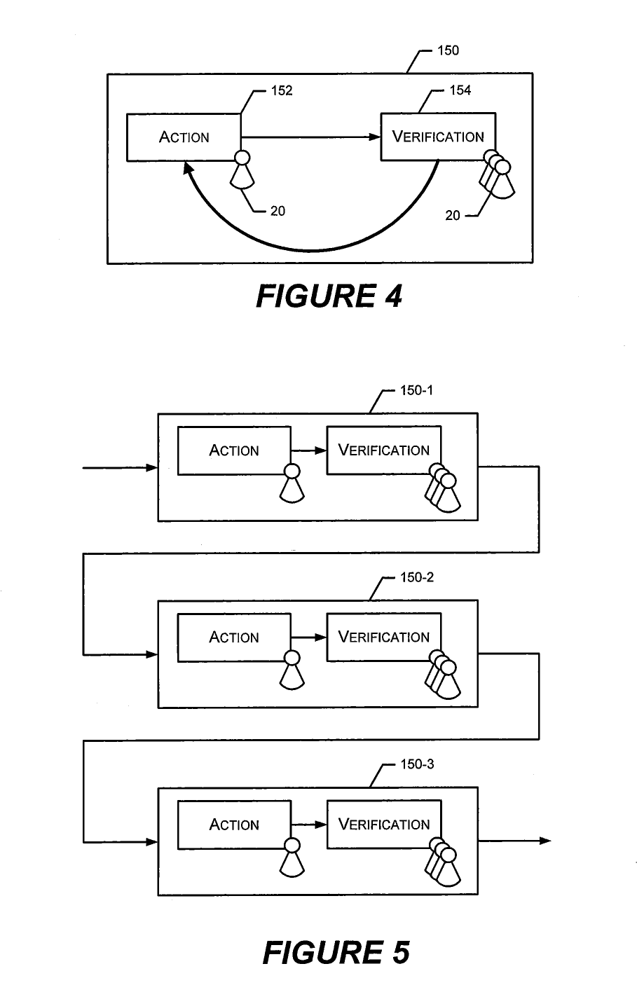

Reference is now made to FIG. 4, which is a block diagram illustrating an example of an action verification unit that may be used to define collaboration patterns for crowdsourcing according some embodiments of the present inventive subject matter. An action verification unit 150 may provide an element that may be used as a building block for a collaboration pattern. Although used to explain concepts herein, the action verification unit 150 is just one example of the different collaboration pattern elements and/or types of collaboration pattern elements that may be used as building blocks for collaboration patterns. The action verification unit 150 includes an action 152 that may identify and/or define a task for a human asset 20 to perform. In some embodiments, the action 152 may be referred to as a human intelligence task (HIT). The action verification unit 150 may include a verification 154 that may identify and/or define how completely and/or well the action 152 has been performed. The verification 154 may be performed by one or more other human assets 20. If the results of the verification 154 indicate that the action 152 is not performed completely or satisfactorily, the action 152 may need to be re-performed and/or improved. If the results of the verification 154 indicate that the action 152 has been performed satisfactorily and completely then the action 152 may be accepted, in which case the task corresponding to the action verification unit 150 may be considered complete. In this manner, and iterative process may be provided through which the task may be performed and verified using crowdsourcing.

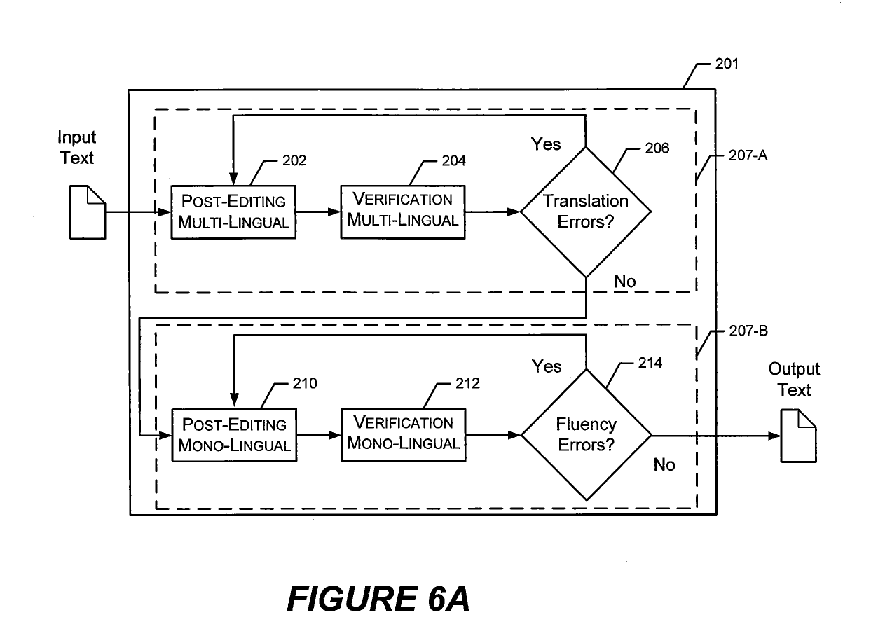

Brief reference is now made to FIG. 5, which is a block diagram illustrating multiple action verification units that may be used in collaboration patterns for complex crowdsourcing tasks according to some embodiments of the present inventive subject matter. As discussed above regarding FIG. 4, the action verification unit 150 may provide an element that may be used as a building block for collaboration pattern. In the case of a complex process and/or task, multiple action verification units 150 may be used to define the complex process and/or task into multiple subtasks that may each be performed and verified. For example, in the case of a series of subtasks to be performed serially, a first subtask corresponding to a first action verification unit 150-1 may be performed and verified before performing a second subtask corresponding to a second action verification unit 150-2 that may be performed verified before forming a third subtask corresponding to a third action verification unit 150-3. Although the subtasks and action verification units 150 are illustrated as being performed in the serial manner, the complex tasks may include one or more combinations of serial and/or parallel subtasks and corresponding action verification units 150.

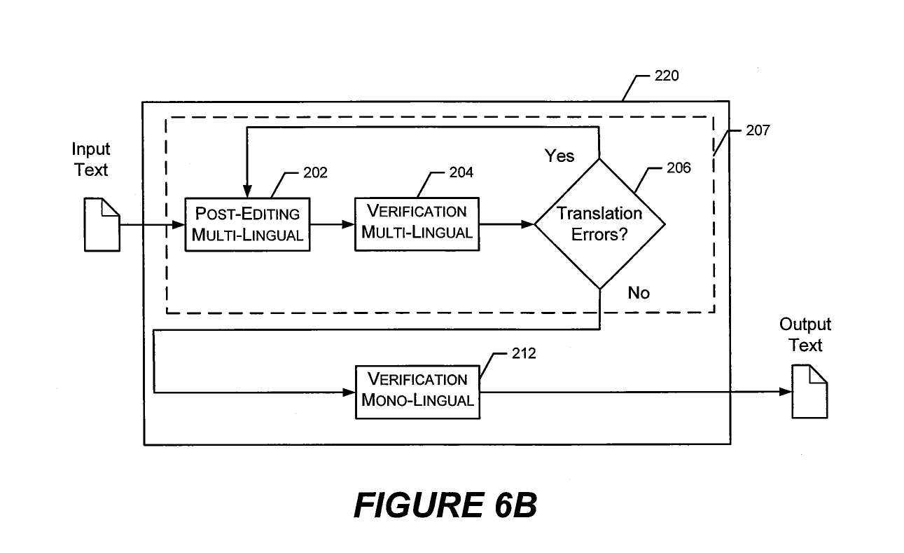

FIG. 6A-6D are block diagrams illustrating different collaboration patterns with different complexities for crowdsourcing a text translation from one language to another language according to some embodiments of the present invention. In some embodiments, the translation may be performed as a crowd localization process in which documents intended for use in a particular geographical region may be provided using human assets local to the region.

Some embodiments provide that selection of the different collaboration patterns may be conditional. For example, the expertise, ranking and/or amount of information regarding the expertise of the human assets may be a factor in determining which of the collaboration patterns is selected. In some embodiments, schedule and/or cost constraints may be conditions that factor into the selection of a collaboration pattern. For example, referring to FIG. 6A, a first collaboration pattern may be useful in the circumstance where the human assets may have low or unknown rankings and/or where a completion schedule and/or budget may be less restrictive. For example, an initial post-editing operation 202 may be performed to input text by multi-lingual human assets. By way of example, the input text may be a machine translated text document, however, such example is non-limiting. The post editing action 202 may be verified 204 by one or more other multilingual human assets to determine the quality of the post editing action 202. In some embodiments, the verification 204 may include a determination regarding translation errors (Block 206). If translation errors are identified then additional post editing 202 may be performed and verified 204. If no translation errors or an acceptable level of translation errors are identified in the verification 204 then the action verification unit 207-A may be considered complete in providing a post editing action that is substantially free of translation errors. In addition to and/or as a part of the verification 204, the multi-lingual human assets may provide feedback corresponding to the human asset performing the post editing 202. For example, feedback may include rating and/or ranking data corresponding to one or more different categories of performance, which may be determined based on the nature of the action being performed.

The collaboration pattern 201 may also include a second action verification unit 207-B that may correct or reduce fluency errors from the text that has been post edited to correct or reduce translation errors (Block 207-A). For example, a post editing action 210 may be performed by a monolingual human asset to address fluency errors in the text that may have been undetected and/or introduced. If fluency errors are detected (Block 214) then additional post-editing activities may be performed before the action is verified and/or accepted. In addition to and/or as a part of the verification 212, the mono-lingual human assets may provide feedback corresponding to the human asset performing the post editing 210. For example, feedback may include rating and/or ranking data corresponding to one or more different categories of performance, which may be determined based on the nature of the action being performed.

Thus, the collaboration pattern 201 includes two action verification units 207-A,B, which are serially arranged. This collaboration pattern 201 may be selected where a quality threshold is particularly high, a human asset expertise level and/or rank is relatively low, the project has relatively low schedule constraints, and/or where the budget is sufficiently high to pay for the numerous different human assets and/or activities.

Referring to FIG. 6B, the operations as discussed above regarding action verification unit 207-A in FIG. 6A may be repeated according to action verification unit 207. As such, repeated discussion thereof will be omitted. However, instead of action verification unit 207-B, collaboration pattern 220 merely includes a subsequent verification 212 to be performed by a mono-lingual human asset to detect fluency errors. In this regard, action of post-editing by a mono-lingual human asset may be avoided, which may reduce the time to complete the task and/or the cost of crowdsourcing the task.

Referring to FIG. 6C, the operations as discussed above regarding action verification unit 207-A in FIG. 6A may be repeated according to action verification unit 207. As such, repeated discussion thereof will be omitted. Additionally, in contrast with FIG. 6B, the verification 212 for fluency by a monolingual human asset may be omitted. This collaboration pattern may be selected based on a ranking and/or expertise of the human assets performing the operations corresponding to the action verification unit 207. Additionally, by eliminating the fluency related operations, cost and/or schedule benefits may be realized relative to the collaboration patterns corresponding to FIGS. 6A and 6B.

Brief reference is made to FIG. 6D, which illustrates a collaboration pattern 240 that includes post editing action 202 performed by a multilingual human asset. This collaboration pattern may be selected when human assets performing the post editing action 202 are considered to have a very high ranking and/or expertise. In addition to considering the ranking and/or expertise of the human assets, selection among the different collaboration patterns may depend on the accuracy level required for the final output text. For example, when translating a text for relatively simple communications and/or that corresponds to a relatively inconsequential quality level deviation, the output text from the collaboration pattern 240, as illustrated in FIG. 6D, may be sufficient. In contrast, when translating a text including significantly sophisticated content and/or the may correspond to serious consequences for a poorly translated text, the collaboration pattern 201 corresponding to FIG. 6A may be selected.

In some embodiments, the collaboration patterns 201, 220, 230 and 240 illustrated in FIGS. 6A-D may be considered as a single conditional pattern in that, as long as the time available is smaller and/or the quality of the workers involved is higher, some steps in this pattern can be omitted. In this way the pattern maybe dynamically adapted based on the information regarding the human assets.

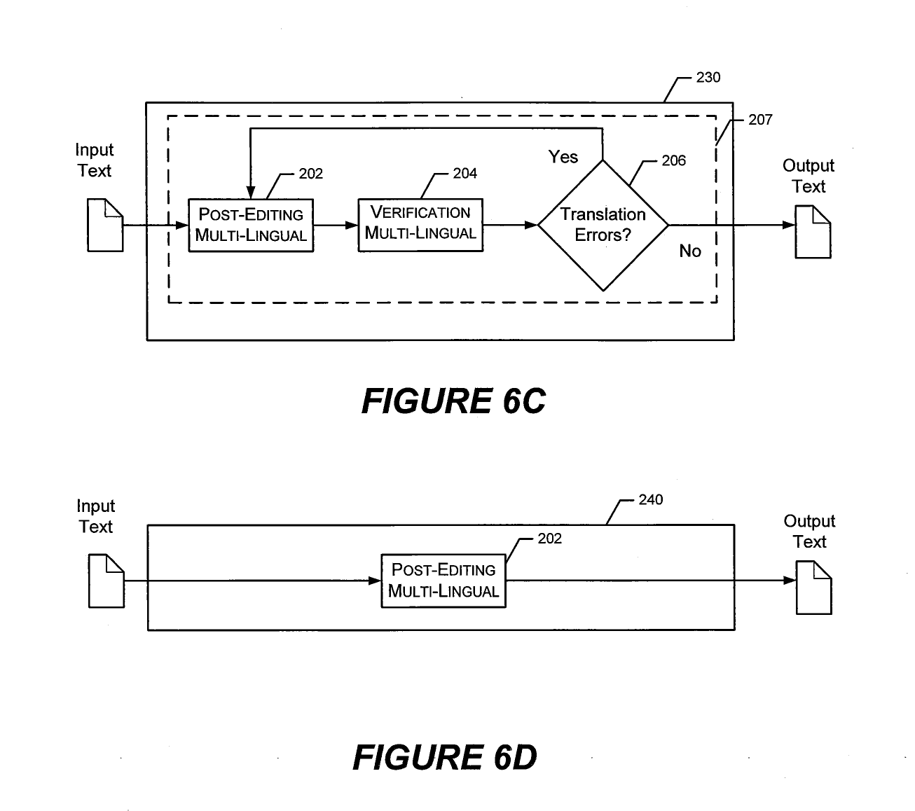

Reference is now made to FIG. 7, which is a block diagram illustrating different collaboration patterns that may be generated for new types of tasks according to some embodiments of the present invention. In some embodiments, a complex task that may be represented by a single action verification unit 300 may be divided into a number of different subtasks, including different action verification units and/or types thereof. In some embodiments, a user may generate new and/or edit existing collaboration patterns to accomplish the crowdsourcing task. A collaboration pattern editor may provide a user with a graphical user interface through which to create different collaboration patterns and/or types thereof. For example, the action verification unit 300, may include an action to be performed by a human asset 20 and voting 304 that may be reported by other human assets 20. Another type of action verification unit 310 may include multiple different actions 312A-C that may be performed by different human assets 20. The verification operation may include voting 314 at different ones of the human assets 20. In some embodiments, the voting may be used to rank the different actions 312A-C, however such embodiments are nonlimiting.

An action verification unit 320 may include an action 322 that may be verified 324 by an organization and/or standards body such as, for example, a non-governmental organization (NGO). By way of example, an action verification unit 330 may be provided after a series of other action verification units and/or types thereof and may provide a final verification corresponding to multiple subtasks in a crowdsourcing task.

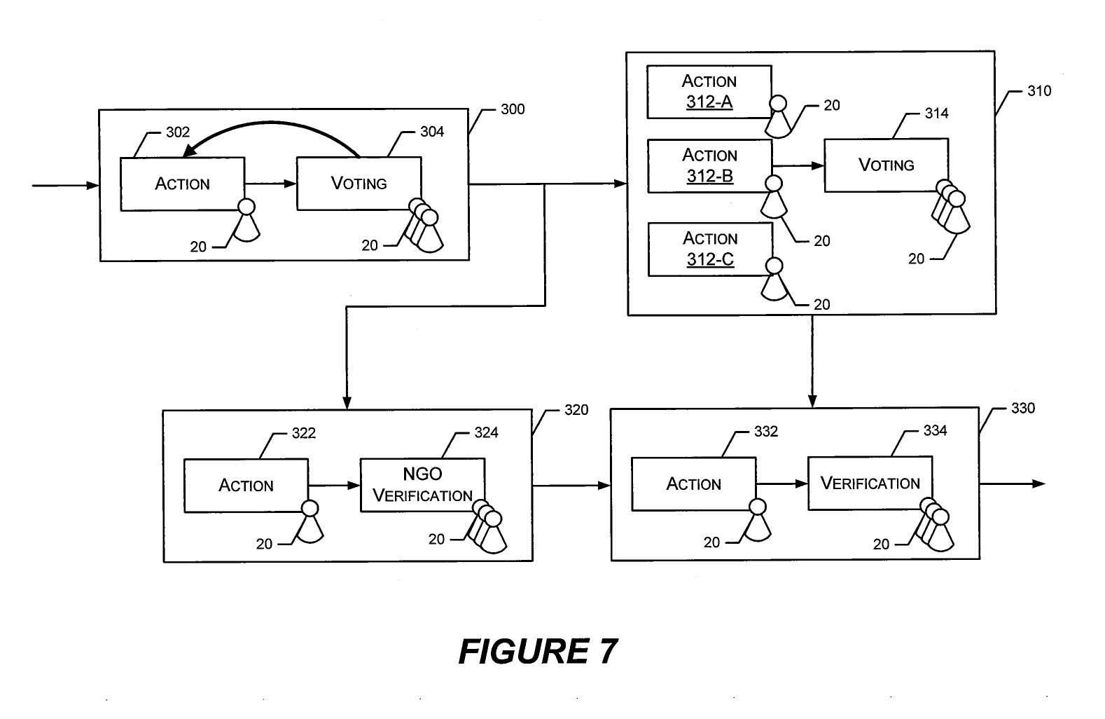

Reference is now made to FIG. 8, which is a block diagram illustrating a use case for using crowdsourcing to write a travel book according to some embodiments of the present invention. In the illustrated example, a publisher for example may want to publish one or more travel books. The solid line blocks illustrated may indicate a typical business process for publishing a travel book. The dashed line blocks may identify examples of which of the subtasks in the process for publishing the travel book may be crowdsourced. For example, a destination may be selected (Block 402) using one or more crowdsourcing tasks 420. An example collaboration pattern that may be used for selecting the destination may include an action verification unit with a voting operation corresponding to verification. In this manner, the “crowd” may provide information regarding which destination may be the most interesting in the context of a travel book.

Once the destination is selected, multiple different tasks may be performed via crowdsourcing 420. For example, collaborative patterns may be developed to identify points of interest 404-A, best places to eat 404-B and best places to sleep 404-C corresponding to the selected destination. Example collaborative patterns for such tasks may include voting patterns among others. As illustrated, a publisher or author may decide a book structure (Block 406), however this task may also be crowdsourced, using, for example, a voting pattern to select among different book structures and/or attributes. In some embodiments, the book structure attribute may include an order of content, a type of illustration and/or whether the book is published with a hard cover or soft cover, among others.

The individual chapter writing (Block 408) may also be crowd sourced and may include writing tasks, coordination tasks, post editing tasks and/or reviewing tasks, among others. Once chapters are written, the book maybe printed (Block 410) and support information may be published (Block 412). After publication, subsequent crowdsourcing tasks may be used to update information (Block 414) so the subsequent editions of the book maybe published with current information. By virtue the systems and methods herein, the publisher may create and organize collaboration patterns corresponding to the multiple different subtasks to be crowd sourced.

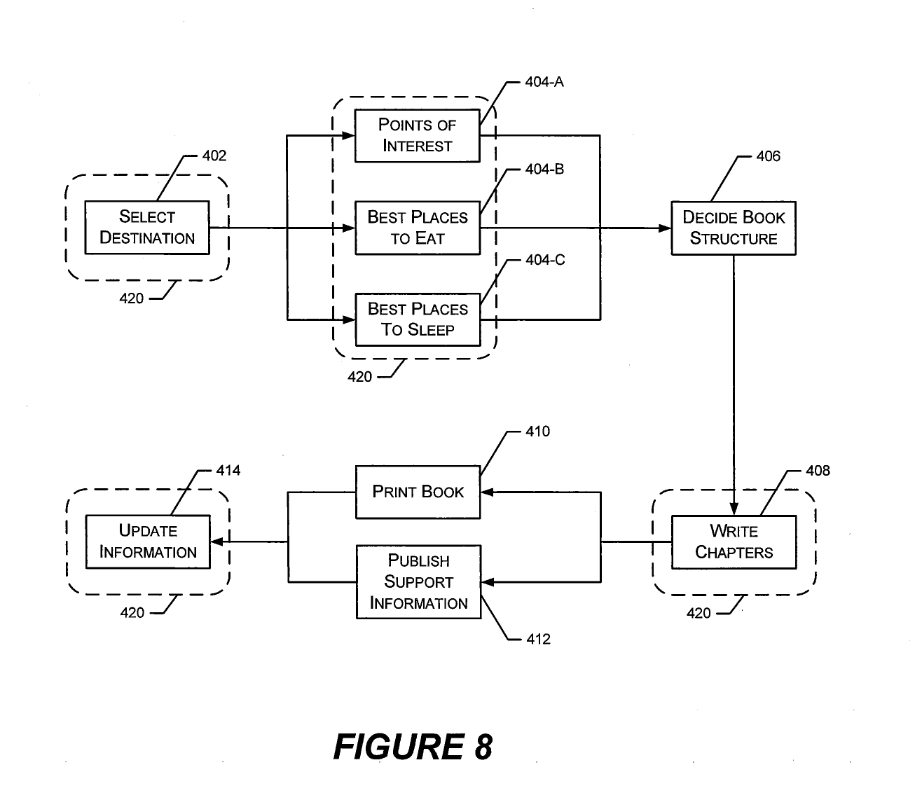

Reference is now made to FIG. 9, which is a flowchart illustrating operations for systems/methods according to some embodiments of the present inventive subject matter. Crowdsourcing project input information may be received (Block 502). The input information may include a set of requirements for completing the crowdsourcing project. A collaboration pattern corresponds to the crowdsourcing project and that identifies human intelligence tasks may be generated (Block 504). Some embodiments provide that the collaboration pattern may be generated by accessing a library that includes multiple basic collaboration patterns. Different ones of the basic collaboration patterns that correspond to the crowdsourcing project may be selected.

Once a collaboration pattern is generated, the collaboration pattern may be edited and revised by user. In some embodiments, the collaboration pattern includes a complex collaboration pattern. In such embodiments, multiple different ones of the basic collaboration patterns may be combined to generate the complex collaboration pattern. Additionally, some embodiments provide that multiple different collaboration patterns may be presented to the user via a graphical interface and may include data indicating how ones of the multiple different collaboration patterns have performed in previously executed similar crowdsourcing projects. Besides the ability to create arbitrarily complex conditional patterns, embodiments described herein may also include a library of frequent collaboration building blocks (voting systems, iterative review processes, etc.), so that users can use these elementary building blocks to compose the collaboration patterns. Some embodiments provide that newly defined collaboration patterns can turn into building blocks, promoting their reuse.

The human assets to perform the human intelligence tasks may be identified based on one or more human asset specific characteristics (Block 506). Some embodiments provide that human assets may be selected by the system. In some embodiments, the tasks may be published and the human assets may select tasks that they want to perform. Depending on the profile of the human worker and/or the collaboration pattern, a query engine may adapt the collaboration pattern to provide a requisite level of quality, for example. Some embodiments provide that the human asset specific characteristic includes human asset quality ranking, human asset experience, human asset skill type, and/or human asset skill combinations, among others. In some embodiments, human asset performance information corresponding to performance of the human intelligence task may be received (Block 508).

In some embodiments, the collaboration pattern may include an action verification unit in which a first human asset is allocated to perform one of the human intelligence tasks and a second human asset is allocated to verify the completion of the one of the human intelligence tasks. In some embodiments, allocating a human asset may include identifying human assets that select tasks that they want to perform based on the task and/or collaboration pattern being published. Some embodiments provide that the second human asset may include multiple human assets that provide task verification information and that the human intelligence task may be completed iteratively responsive to the task verification information. In some embodiments, iteratively completing the human intelligence task may include repeating the human intelligence task responsive to the verification information indicating that the human intelligence task is not performed satisfactorily, performing subsequent activities on the human intelligence task responsive to the verification information indicating that the human intelligence task is incomplete and/or verifying that the human intelligence task is complete.

Once the collaboration patterns are generated edited and/or finalized, the human intelligence tasks may be executed according to the collaboration pattern by assigning corresponding ones of the human assets to the human intelligence tasks (Block 510). Some embodiments provide that assigning a human asset to a task may include receiving indication that the human asset chooses the task. In some embodiments, mechanisms for encouraging those human assets more suited to specific tasks may be provided. Since collaboration patterns may be conditional on the expertise and/or ranking of the human assets, information corresponding to the human assets may be beneficial. In this regard, human asset worker profiles corresponding to ones of the human assets may be generated (Block 512). Human asset worker profiles may include human asset performance information and human asset specific characteristics. In some embodiments, the human asset worker profiles may be updated in response to receiving updated human asset performance information and/or an updated human asset specific characteristic (Block 514).

In some embodiments, a ranking of a human asset may be a representation of the quality of that human asset. A definition of ranking can be a predefined one (like the average marks of all the peer evaluations of that human asset's work) or an ad hoc ranking, so that each pattern can define how quality should be measured. In this regard, many different rankings can coexist in the same systems. In some embodiments, a collaboration pattern may specify how these rankings get updated in response to the actions of the human asset in the system. For instance, we could use the percentage of sentences for which verifiers found no error in the first iteration of the action verification unit to determine a ranking value. In this manner, a worker with a ranking 99 would be a worker that correctly post-edits 99% of the sentences, which may indicate that this particular human asset is expert and can be used in collaboration patterns having less subsequent oversight and/or verification.

Some embodiments provide that graphical user interfaces may be generated (Block 516). For example, graphical user interfaces may be generated for interfacing with a collaboration pattern editor that may receive editing inputs that edit a collaboration pattern that corresponds to the crowdsourcing project. Some embodiments provide that a graphical user interface may provide an interface to a human intelligence task editor that may receive inputs corresponding to conditions for each collaboration pattern and each element in the collaboration pattern to provide a dynamic transformation option of the collaboration pattern during execution based on the conditions. Yet further the graphical user interface may provide an interface with a collaboration pattern editor to associate a given user interface with each element in the collaboration pattern and/or with resources associated with each element in the collaboration pattern. For example, elements in collaboration patterns may be tasks.

Server automation/provisioning tools (also referred to as server deployment tools) may be used to manage virtual machines in a cloud computing environment. For example, server automation/provisioning tools may move virtual machines from one hypervisor to another or from one virtualization environment to the other. These tools may also be used, for example, to deploy, provision, activate, suspend, and otherwise manage the operation of virtual machines. These tools may further be used to implement systems/methods according to some embodiments described herein.

Collaboration Pattern Creation by Crowdsourcing Participants

Various embodiments described above can provide for the editing of a collaboration pattern for crowdsourcing, and execution of the edited collaboration pattern. Thus, various embodiments described above can provide a crowdsourcing platform that can be used to coordinate an online workforce that may include up to thousands of users working remotely.

According to various embodiments that will now be described, a crowdsourcing platform may be used to perform co-creation of a collaboration pattern. Specifically, a challenge in crowdsourcing is to find an optimum collaboration pattern so that different, and often anonymous, workers can solve a problem in a collaborative way. Many different factors may be considered in finding an optimum collaboration pattern, such as average time to solve a specific problem, skill set required, number of workers/resources involved in the process to perform a task, outcome quality expected, risk of fraud, deadline requirements, etc. Various embodiments that will now be described enable a collaboration pattern to be created by crowdsourcing participants based on published requirements for a crowdsourcing project that includes a crowdsourcing task. Accordingly, emerging collective intelligence can be used to create collaboration patterns that are used to coordinate workers in a crowdsourcing environment. Stated differently, the crowd may be used to define how the crowd should collaborate to solve a problem remotely and in a collaborative way.

As used herein, a crowdsourcing project is designed to accomplish a specific goal, such as “translate document X from language Y to language Z”. A crowdsourcing task is designed to accomplish a more general goal, such as “translate from language Y to language Z”. A collaboration pattern identifies a series of steps or subtasks to be taken by crowdsourcing participants to perform the task. Each step or subtask may itself be regarded as a task. Stated differently, collaboration patterns are generic mechanisms to solve a particular task that may be used in many projects.

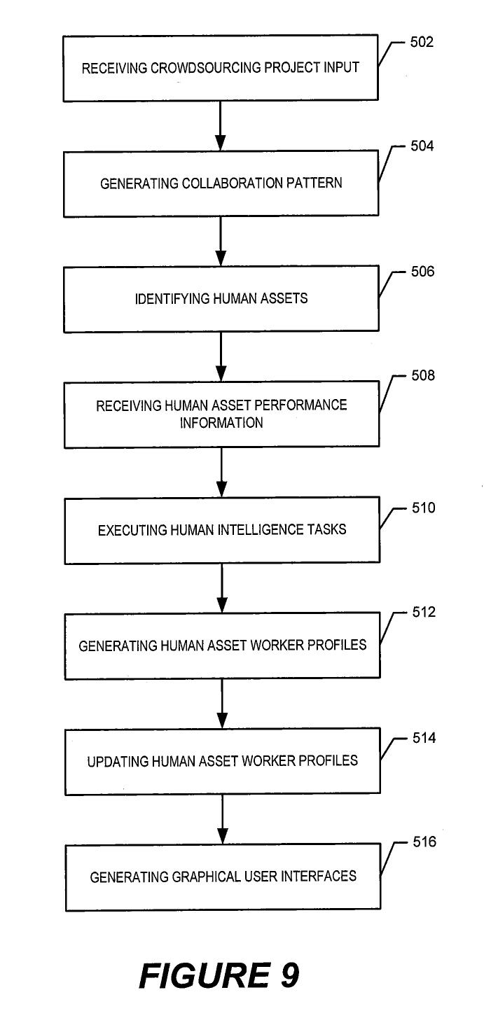

FIG. 10 is a block diagram of collaboration pattern module 130′ according to various embodiments described herein. In FIG. 10, prime (′) designators have been used to identify those elements of FIGS. 1-9 that can be modified to incorporate various embodiments that will now be described so that a requestor can create a collaboration pattern and/or the crowdsourcing participants can create a collaboration pattern. However, other embodiments that will now be described need not be integrated with the embodiments that were described above.

Referring now to FIG. 10, a collaboration pattern module 130′ may be used by one of more crowdsourcing project requestors 10′. A requirements generator 132′ may be used by the requestor 10′ to generate requirements for a crowdsourcing project that comprises a crowdsourcing task. In some embodiments, the requirements do not identify a collaboration pattern that can be used to accomplish the task.

A collaboration pattern co-creation system 160 may be used to publish the requirements for the crowdsourcing project to crowdsourcing participants 20′. The crowdsourcing participants 20′ may include an undefined workforce who participate in crowdsourcing. The participants need not be preselected for a given crowdsourcing project or a given crowdsourcing task, although, in some embodiments, they may be preselected for a given crowdsourcing project or task. Stated differently, the requirements may be published as an open call for anyone to participate. In other embodiments, however, the participants may be restricted to a specific community.

The crowdsourcing participants 20′ may use a collaboration pattern editor 134′ and/or other mechanisms to propose candidate collaboration patterns for the crowdsourcing task. It will be understood that the crowdsourcing participants who propose candidate collaboration patterns may be a subset, and in some embodiments a small subset, of the crowdsourcing participants to whom the requirements are published. The candidate collaboration patterns may be a selection from a collaboration pattern library 136′, a modification of a collaboration pattern in the library 136′ or a new collaboration pattern that is not based upon a collaboration pattern in the library 136′. The collaboration pattern editor 134′ may be used to define the new collaboration pattern, to select the preexisting collaboration pattern from the library 136′ and/or to modify the preexisting collaboration pattern in the library 136′.

The requestor 10′ selects one of the candidate collaboration patterns, for example by using the collaboration pattern co-creation system 160. Once the requestor 10′ selects a candidate collaboration pattern, a collaboration pattern execution engine 138′ may be used to execute the crowdsourcing project using the selected candidate collaboration pattern to perform the crowdsourcing task. Accordingly, requestors may publish a new task and a set of requirements, and workflow proposers may work remotely to create new workflows and publish them. Requestors then may select the workflows that fit their requirements. It will be understood that the crowdsourcing project may be used or executed by crowdsourcing participants who are a subset of, or disjoint from, the crowdsourcing participants who proposed the workflow. Thus, people proposing workflows may have nothing to do with people executing the workflows.

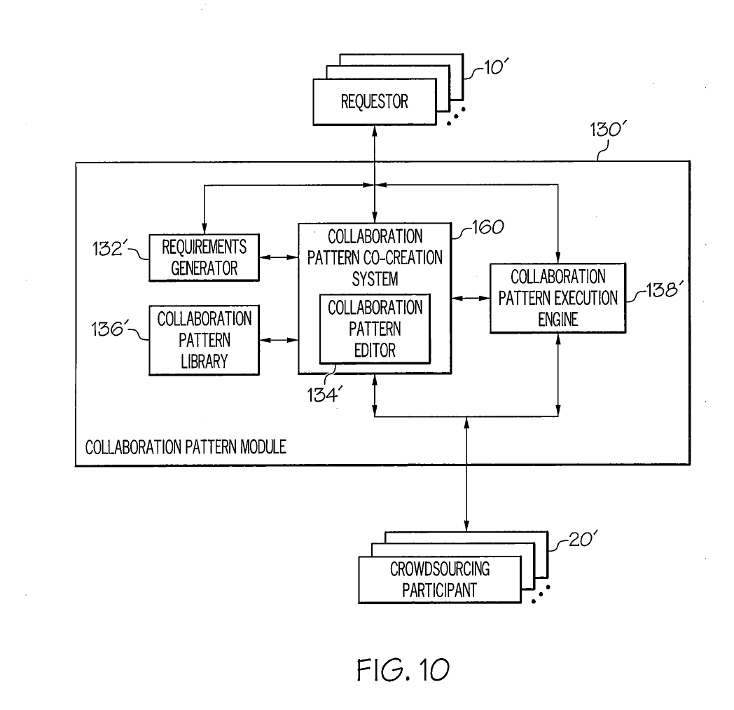

FIG. 11 is a flowchart of operations that may be performed to create and execute a collaboration pattern for a crowdsourcing project according to various embodiments described herein. These operations 1100 may be performed by a collaboration module 130′ as illustrated in FIG. 10.

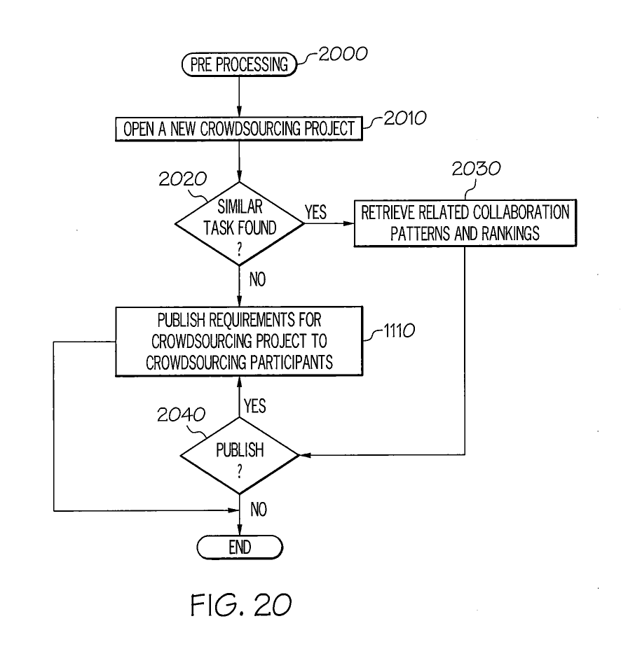

Referring to FIG. 11, at Block 1110 requirements for a crowdsourcing project that includes one or more crowdsourcing tasks, are published to crowdsourcing participants. As was noted above, the crowdsourcing participants may be an entire community of Internet users or may be limited to smaller communities. In some embodiments, the requirements generator 132′ of FIG. 10 is used to establish the requirements, and the collaboration pattern co-creation system 160 of FIG. 10 is used to publish the requirements to the crowdsourcing participants 20′. In some embodiments the requirements for the crowdsourcing project do not identify a collaboration pattern but only identify the task(s) to be performed, an average time to solve a specific problem, skill set required, number of workers/resources involved in the process to perform a task, outcome quality expected, risk of fraud, deadline requirements, etc. The requirements may be expressed as a narrative and/or by using a dashboard interface to indicate metrics of various parameters that are used to define the requirements. For example, a dashboard may be used to indicate skill set, outcome quality, etc. In still other embodiments, preprocessing may be performed prior to publishing the requirements at Block 1110, as will be described in detail in connection with FIG. 20.

Still referring to FIG. 11, at Block 1120 candidate collaboration patterns for the crowdsourcing task are received from ones of the crowdsourcing participants. In some embodiments the candidate collaboration patterns are received by allowing the crowdsourcing participants 20′ to access a collaboration pattern editor such as the collaboration pattern editor 134′ of FIG. 10, so that a crowdsourcing participants 20′ can select as a candidate collaboration pattern a pre-existing collaboration pattern from the collaboration pattern library 136′, can modify a collaboration pattern in the library 136′ using the collaboration pattern editor 134′, or can use the collaboration pattern editor 134′ to create a new collaboration pattern that is not based upon a collaboration pattern in the library 136′. In other embodiments direct access to the collaboration pattern library 136′ may be provided to the participants 20′, without the intermediary of access by a collaboration pattern co-creation system 160 and/or a collaboration pattern editor 134′.

Referring again to FIG. 11, at Block 1130, one of the candidate collaboration patterns is selected by the requestor 10′, for example, by interacting with the collaboration pattern co-creation system 160 and evaluating the candidate collaboration patterns that were submitted. In some embodiments, an expert system may be provided in the collaboration pattern co-creation system 160 to allow the candidate collaboration patterns to be evaluated relative to the published requirements, as will be described in detail below. At Block 1140, the crowdsourcing project is executed using the one of the candidate collaboration patterns that was selected, to perform the crowdsourcing task. It will be understood that the crowdsourcing participants who execute the crowdsourcing project at Block 1140 may overlap fully or partially, or may be non-overlapping with, the crowdsourcing participants who provide candidate collaboration patterns at Block 1120. The execution may be performed using the collaboration pattern execution engine 138′. Finally, at Block 1150, post processing may be performed, as will be described in detail below.

Accordingly, in some embodiments of FIG. 11, all proposed collaboration patterns that are created or modified by crowdsourcing participants 20′ are published, for example by including them in the collaboration pattern library 136′. Among those, one of them is selected when a task needs to be solved. Selection is performed by a requestor 10′ with the help of a search tool that allows retrieving available workflows for a particular task in a particular order based, for example, on a score that evaluates how good the workflow is, for example based on the requirements defined by the requestor and the characteristics of the collaboration pattern.

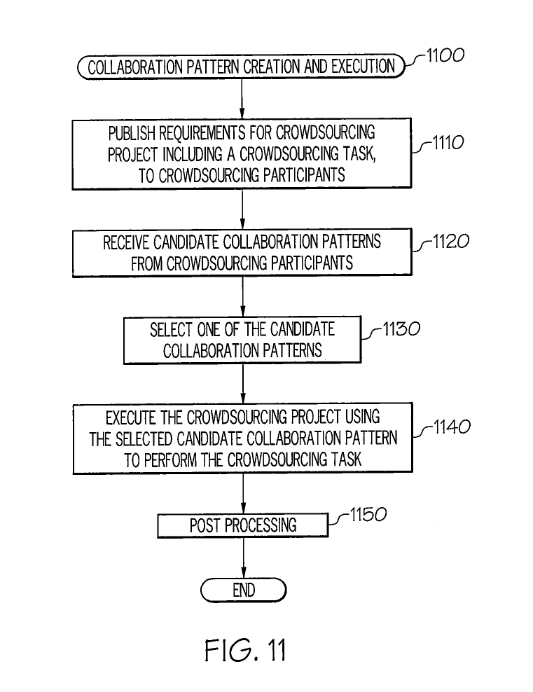

FIG. 12 illustrates other embodiments wherein the receiving (Block 1120) is repeatedly performed prior to performing the selecting (Block 1130). More specifically, after receiving the candidate collaboration patterns from crowdsourcing participants of Block 1120, it may be determined by the requestor 10′ and/or automatically by the collaboration pattern module 130′, that additional crowdsourcing participant input may, be desired. For example, none of the candidate collaboration patterns may meet all the requirements so that it may be desired to receive additional evaluation from the crowdsourcing participants 20′. Alternatively, two or more acceptable candidate collaboration patterns may be received and it may be desirable to allow the crowdsourcing participants to evaluate these multiple acceptable candidate collaboration patterns relative to one another. There may also be additional reasons why it may be desirable to receive new candidate collaboration patterns and/or other comments from the crowdsourcing participants 20′. Thus, at Block 1210, if additional participant input is desired, the operations of Block 1120 can be performed repeatedly until additional input is no longer desired and the selection may be made at Block 1130.

Thus, the candidate collaboration patterns may be automatically published by the crowdsourcing participants 20′ using the collaboration pattern co-creation system 160, when they are created. A continuous open call may thereby be maintained for each task that is being considered, so that participants can repeatedly suggest improvements for these tasks. In some embodiments, the system may prioritize those tasks that are waiting to be executed to have a workflow available, so that participants can prioritize these if they wish. In still other embodiments, the requirements themselves may be republished at Block 1110 if there is a change in the original requirements. Otherwise, the requirements may always remain a public event after they are initially published to the crowdsourcing participants.

Moreover, as also illustrated at FIG. 12 at Block 1220, after selecting one or more of the candidate collaboration patterns at Block 1130, additional participant input may be desired. For example, the requestor 10′ may review the candidate collaboration patterns, but decide that two or more of the collaboration patterns may satisfy the requirements for the task and may, therefore, request additional comments or modification of the candidate collaboration patterns, to identify a best collaboration pattern. In another example, none of the candidate collaboration patterns may satisfy the requestor's requirements completely. Accordingly, the requestor 10′ may select one of the candidate collaboration patterns, but may request additional modifications from the participants to satisfy all of the requirements. If so, the one or more candidate collaboration patterns may be identified (Block 1230) so as to receive additional candidate collaboration patterns or other comments (Block 1120) prior to making a final selection at Block 1130 and execution at Block 1140.

In summary, the individual operations of Blocks 1110, 1120 and 1130 may be performed repeatedly as separate operations or as groups of operations to further refine candidate collaboration patterns that are generated for the crowdsourcing task from the crowdsourcing participants.

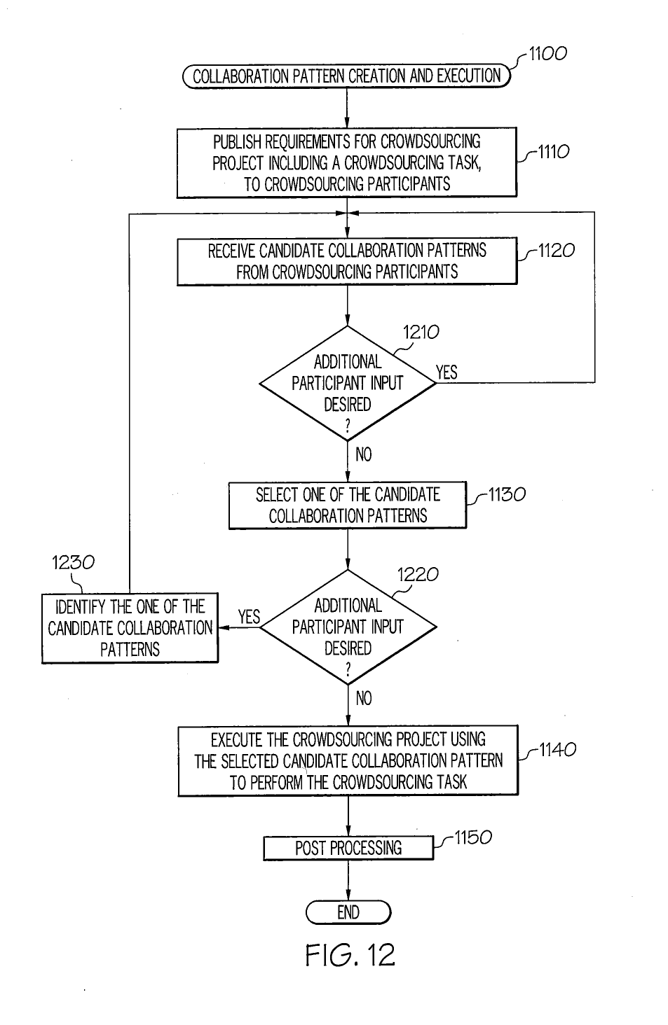

FIG. 13 is a flowchart of operations that may be performed to select one of the candidate collaboration patterns that were received, which may correspond to operations of Block 1130. These operations may be used to generate effectiveness metrics for the candidate collaboration patterns.

Specifically, at Block 1310, results profiles are generated for the candidate collaboration patterns. A results profile may compare the candidate collaboration pattern against the requirements that were published at Block 1110. The results profile may be expressed using a graphical user interface. Then, at Block 1320, scores are generated for the candidate collaboration patterns based on the results profiles that were generated. The scores may weight different aspects of the results profile differently, based on an input by the requestor of which of the requirements are more important. Finally, at Block 1330, the candidate collaboration profiles are ranked according to the scores. The rankings may allow the requestor to select the highest ranked candidate collaboration pattern at Block 1130. Accordingly, FIG. 13 can provide an embodiment of an expert system that may be used to help the requestor select a candidate collaboration pattern from those submitted by the participants.

As was described above, in some embodiments a candidate collaboration pattern may be a selection, by a crowdsourcing participant, from a library 136′ of collaboration patterns, may be a modification of the collaboration pattern in the library 136′ or may be a new collaboration pattern that is not based upon a collaboration pattern in the library 136′. When an existing collaboration pattern in the library or a modification of an existing collaboration pattern in the library is selected to solve a particular task, the results profile from the collaboration pattern in the library that was used to solve the task in a different project may be used. Thus, a results profile from another crowdsourcing project that includes the collaboration pattern may be used to generate a results profile for the candidate collaboration pattern. Stated more simply, a results profile may be generated from a results profile for the same task that was used in a different project.

Alternatively, when the candidate collaboration pattern is a new collaboration pattern for a new task that is not based upon a collaboration pattern in the library, it may be difficult to generate a results profile. Accordingly, in some embodiments, the results profile of Block 1310 is generated from a related task, when results of a crowdsourcing project are not available for the given task. Thus, the results profile may be generated based on results of another similar task that was part of a similar candidate collaboration profile.

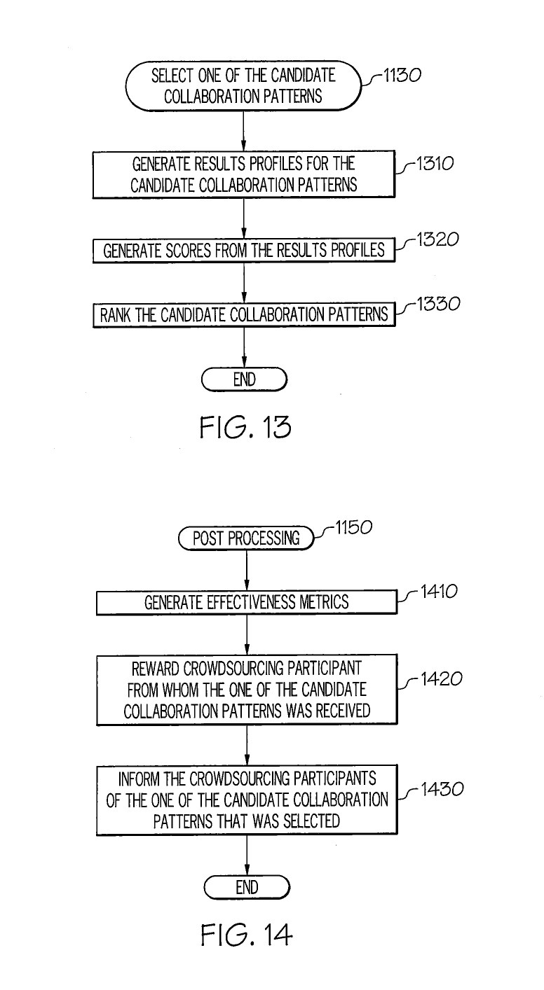

FIG. 14 is a flowchart of post processing operations that may be performed, which may correspond to Block 1150 of FIG. 11. Referring to FIG. 14, at Block 1410 one or more effectiveness metrics may be generated for the one of the candidate collaboration patterns that was selected at Block 1130, based on results of the executing the crowdsourcing project using the selected candidate collaboration pattern at Block 1140. Moreover, at Block 1420 a crowdsourcing participant 20′ from whom the selected candidate collaboration pattern was received may be rewarded. The reward may be monetary, reputational and/or otherwise. In other embodiments, all the crowdsourcing participants who suggested a candidate collaboration pattern or otherwise aided the collaboration co-creation may be rewarded to a greater or lesser extent. Also, as illustrated at Block 1430, in some embodiments, the crowdsourcing participants may be informed of the one of the candidate collaboration patterns that was selected, so that they may have this information for future use.

Additional discussion of various embodiments that were generally described in connection with FIGS. 10-14 will now be provided. Specifically, solving complex tasks through crowdsourcing generally requires the design of collaboration patterns that describe the process flow used to coordinate remote workers in the crowd and the data exchanged by these different workers in executing the crowdsourcing task. Depending on the process design (subtask division, requirements for each subtask, complexity of tasks, etc.) the output quality may vary. Many different factors generally may be important: time to solve a specific problem, skillset required, number of workers/resources involved in the process to perform a task, outcome quality expected, risk of fraud, deadline requirements, etc.

Finding the optimum process design (optimum collaboration pattern) in a crowdsourcing environment is a problem that does not appear to be well understood. Previous attempts to design and control crowdsourcing workflows were generally supervised by the requestor. In some of them, the requestor does not necessarily need to participate. However, previous experiments show that when the requestor does not participate, results may be far from optimal. In any case, requestors generally have not been provided with a mechanism to explore other collaboration patterns used in the past and to reuse them.

The roles of requestors and collaboration pattern designers are generally merged in previous solutions. These solutions assume that the requestor has the knowledge and control to understand how to split the task in subtasks. However, in reality, many organizations interested in using crowdsourcing might lack experience to create a workflow that uses crowd resources. For example, small and medium enterprises or other organizations such as NGOs, might be interested in using crowdsourcing platforms, but they may not be willing or able to contract crowdsourcing experts. The same may happen for large enterprises that initially may not trust crowdsourcing to solve a specific task and may want to try starting crowdsourcing from low cost pilots.

In general, allowing as many organizations as possible to adopt crowdsourcing may help growing crowdsourcing communities in generalizing the adoption of such solutions. These types of mechanisms might be crucial to start growing generic crowdsourcing platforms devised to solve generic tasks for which collaborations patterns might not yet be available. Moreover, the number of users that are expert on creating collaboration patterns may be limited and it may not be straightforward to find resources with the necessary skillsets to create a crowdsourcing flow.

According to various embodiments described herein, at least partially unsupervised collaborative creation of complex collaboration patterns may be provided using social mechanisms based on collaboration rankings and a mechanism to reuse previous patterns, taking into account different criteria. As was described above in connection with FIGS. 10-14, various embodiments described herein can provide a system to support decision making processes when it is desired to design a collaboration pattern for a specific task. The crowdsourcing community can be engaged in creating their collaboration patterns and therefore spread the understanding of what is a crowdsourcing platform and how users may work collaboratively through one of these platforms.

As was described above in connection with FIGS. 10-14, in some embodiments, the crowd will be able to create and refine patterns in a collaborative way. Moreover, mechanisms may be provided to monitor the execution of each pattern using automatic monitoring techniques and/or social feedback from crowdsourcing platform users. Searching for the best patterns given a set of constraints may also be provided, based on business level requirements such as deadlines, quality needs, budget, etc. As was also described in connection with Block 1420, rewarding mechanisms also may be included to encourage workers in the crowd to create successful collaboration patterns and may take into account reputational aspects about the users involved in the creation of such patterns or flows.

Crowdsourcing has evolved to exploit the work potential of large crowds remotely connected through the Internet. Currently, a variety of crowdsourcing platforms like Amazon's Mechanical Turk, CrowdFlower, ClickWorker or Sama-source are offering frameworks where (relatively simple) tasks can be dynamically posed to a large and readily available workforce. However, the degree of sophistication of generally valuable tasks like data enrichment or content services is often limited to annotating objects in pictures, classifying documents according to taxonomies, finding relevance between search results or OCR clean-up of digitized content.

The effective integration of paid or voluntary crowdsourcing into today's business processes, innovation management, and information management is a heavily worked on, but still largely unsolved, problem. Studying this problem could provide many advantages. For example, if at creation time each project can be effectively broken down to manageable tasks and a viable time plan, it can be fulfilled very efficiently by a crowd of skilled workers. As opposed to a standing workforce, elasticity may be provided: peaks and slumps in activity can be dynamically handled and missing expertise or competences can be contracted. Thus, the efficiency of the overall project may be improved. This is especially true for the basic question of what and where people work. The ubiquity of sophisticated mobile devices and communication services allow for almost unlimited flexibility and freedom in negotiating and outsourcing short-term work contracts and delivering results. In any case, the flexibility with respect to the place where services are actually physically provided has dramatically increased.

One of the main challenges in this crowdsourcing scenario is the efficient coordination of these remote workers, especially when the complexity of tasks to be solved through crowdsourcing increases. In a publication entitled Soylent: A Word Processor With A Crowd Inside, Bernstein et al. (Proceedings of the 23nd annual ACM symposium on User interface software and technology, UIST'10, pp. 313-322, New York, N.Y., USA (2010)), propose a special-purpose pattern called a “Find-Fix-Verify” pattern to perform tasks like text shortening and proofreading. They split the tasks into a series of stages that utilize independent agreement and voting to produce reliable results. At an industrial level, the Action-Verification Unit described, for example, in Crowdsourcing For Industrial Problems (Muntés-Mulero et al., Proceedings of the 1^{st} International Workshop on Citizen Sensor Networks (CitiSen2012), Montpellier, France, (August 2012)), is proposed as a quality control mechanism that helps organize the crowd to perform translations, as well as verification of the quality of the results during the translation process.

Another example of workflow creation and management is presented in Turkomatic, which uses the crowd itself to decide how a complex task should be split. The initial complex task is described by the user, and then a HIT is created in MTurk that simply asks that the worker answer the following question: “Do you believe that this task can be done as a single HIT?” If the answer is Yes, then the task may be posted as is and the results may then be sent to the requestor. On the other hand, if the worker replies No, the worker is asked to split the task into smaller subtasks and to specify their relation. For example, subtasks may be sequential and/or may be solved concurrently. For each of these subtasks, the process may start again. However, iterative behavior does not appear to be supported since all the graphics are acyclic.

The interfaces used in Turkomatic may be primarily textual. As such, no specific/tailored UI for a specific task may be provided. The final result may be that an acyclic graph of tasks is created and executed. Once all the subtasks of a given task are solved, then a new HIT may be created so that a human can merge all the subtasks results to provide a reasonable result for the parent task. Besides allowing the crowd to create this graph, Turkomatic may allow the requestor to provide the graph from the beginning, in various stages of completion ranging from complete to partially specified. However, authors in Collaboratively Crowdsourcing Workflows With Turkomatic, (Kulkarni, et al., Proceedings of the ACM 2012 conference on Computer supported Cooperative Work (CSW '12)/ACM, New York, N.Y., USA, 1003-1012), claim that unsupervised experiments with Turkomatic were not successful.

There may be two main reasons for this apparent lack of success. First, although the crowd can participate in modifying the pattern, they can only subdivide a preexisting step in the flow. In other words, their system does not appear to allow individuals in the crowd to make their own designs. Partial participation of individuals may make it necessary to involve the requestor to act as the global orchestrator. However, this mechanism may become a bottleneck and avoid the full exploitation of the potential of the crowd. Another collaborative mechanism may be required to create collaboration patterns that allows for unsupervised creation of flows. Second, every pattern is created from scratch. Although the system allows giving a partial plan to be completed by the crowd, it does not provide mechanisms to search for preexisting patterns designed for similar tasks. With this, a mechanism to reuse the previous work done by the crowd is not provided.

CrowdWeaver is a system to visually manage complex crowdsourcing work. The system supports the creation and reuse of crowdsourcing and computational tasks into integrated task flows, manages the flow of data between tasks, and allows tracking and notification of task progress, with support for real-time modification. In CrowdWeaver, the creation of collaboration patterns or flows is not crowdsourced. In fact, workers cannot see the complete flows or modify the steps in the process. Workflow transparency has been suggested as an important motivational factor for crowd workers in Workflow Transparency In A Microtask Marketplace (Kinnaird et al., Proceedings of the 17th ACM international conference on Supporting group work (GROUP '12). ACM, New York, N.Y., USA, 281-284). In this paper, the authors compared a text description of the workflow, a visualization of the workflow, and the combination of text and visualization with a control condition without providing workflow information. Workflow transparency marginally increased volunteerism on a charity identification task and significantly increased volunteerism and quality on a business identification task, showing that this may be interesting for both companies and other type of organizations such as NGOs.

In Dynamically Switching between Synergistic Workflows for Crowdsourcing (Lin et al., In Proceedings of the 26^{th} AAAI Conference on Artificial Intelligence, AAAI '12, Dec. 7, 2012, 7 pp.), the authors remark that using a single workflow to accomplish a task may be suboptimal. They propose to use alternative workflows and compose them synergistically to yield higher quality output. However, they do not appear to address the issue of how to build workflows.

Various embodiments described with regard to FIGS. 1-9 above include an editor for collaboration patterns in a crowdsourcing system and an automatic transformation of one or more collaboration patterns into a crowdsourcing platform, allowing for cyclic graphs. These embodiments allow for dynamic patterns that may change at execution time depending on a set of conditions that are preset at design time.

Various embodiments described in connection with FIGS. 10-14 allow for improving or optimizing crowdsourcing collaboration patterns according to a set of criteria that may vary from one task to another with social interaction. An optimization mechanism can allow the community to create collaboration patterns in a collaborative way.

Moreover, various embodiments described in connection with FIGS. 10-14 can allow the crowd to create workflows, where the crowd can access multiple workflows for the same pattern in a transparent way and compare them. As discussed above, workflow transparency has been considered an important motivational factor. Moreover, these embodiments can allow an individual in the crowd to create a complete workflow. Involving the crowd in contributing to create workflows by only allowing them to have partial view of the overall workflow or to modify a single substep in the process, may become an obstacle to converge faster to optimum workflows. Finally, these embodiments can help in the decision making process to find an appropriate workflow given a task and a set of requirements, out of a pool or database of workflows for that particular task.

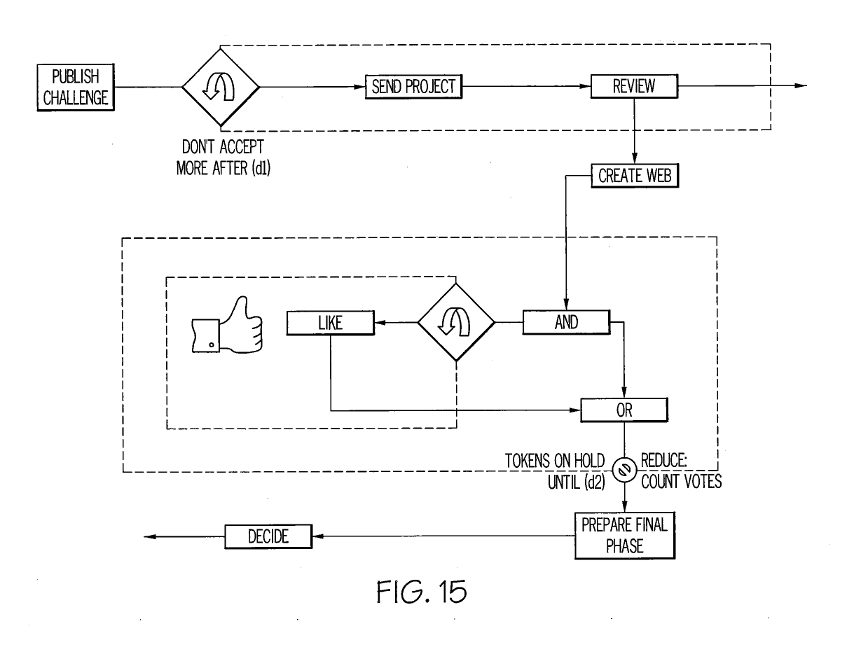

Further discussion of various embodiments described in connection with FIGS. 10-14 will now be provided. A collaboration pattern is used to define the process (workflow) to be followed to carry out a crowdsourcing task for the crowdsourcing project and the collaboration mechanisms to be used by crowdsourcing participants involved in the crowdsourcing project. FIG. 15 illustrates an example of a collaboration pattern. This example is based on Instructables (instructables.com) and shall not be regarded as limiting the scope of various embodiments described herein. Different collaboration patterns may be proposed to solve the same task with different requirements in terms of average time required to execute the process, quality of the output, cost, etc.

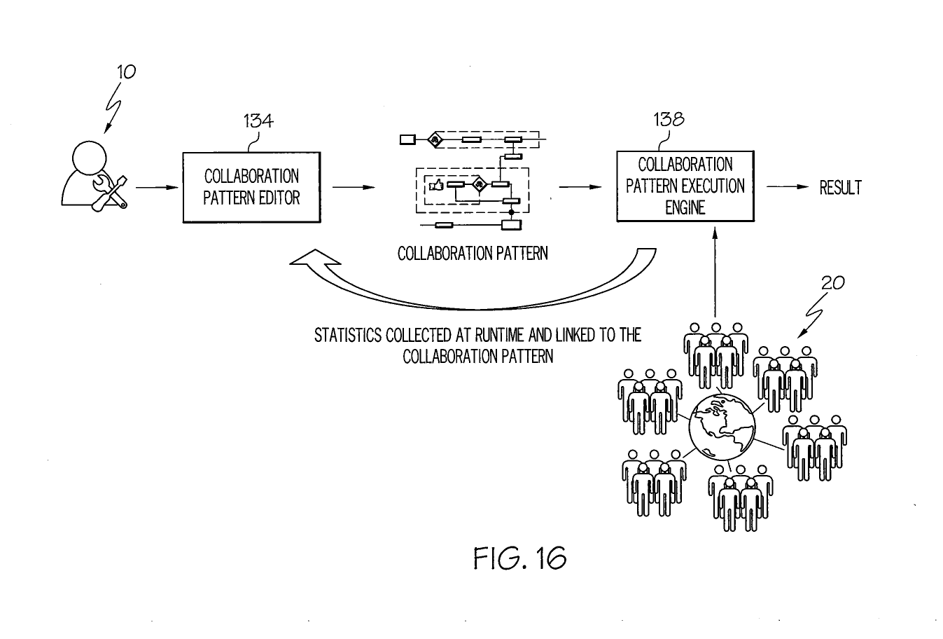

Various embodiments described in connection with FIGS. 1-9 provided an editor to create collaboration patterns and an engine to execute them. These embodiments also allowed monitoring and collecting relevant information about the execution of these collaboration patterns and the behavior of workers in those patterns. FIG. 16 provides a functional diagram of these embodiments.

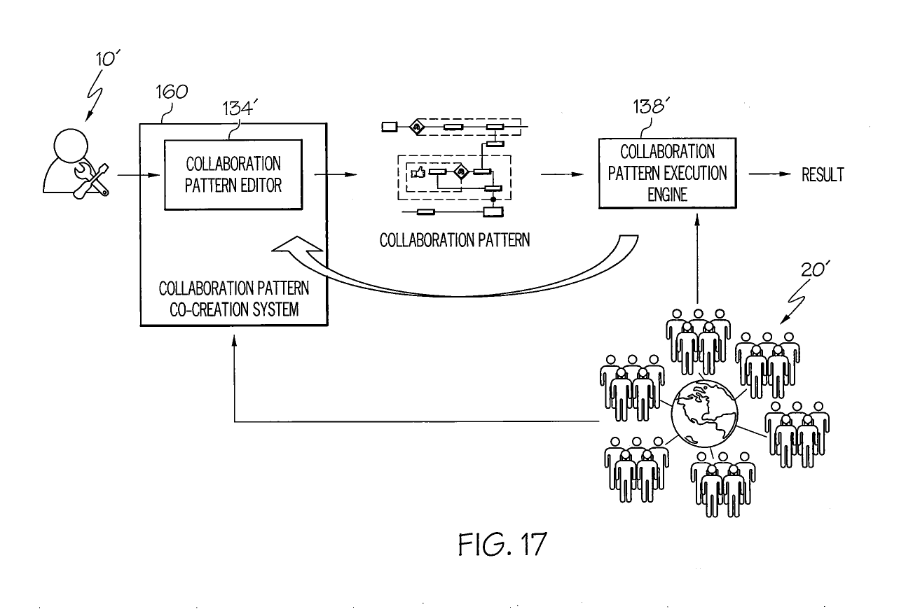

Various embodiments described in connection with FIGS. 10-14 can allow the users in the crowd (i.e., crowdsourcing participants 20′) to collaborate to create, and in some embodiments optimize, collaboration patterns. FIG. 17 provides a functional diagram of these embodiments. As illustrated in FIG. 17, the requestor 10′ can define a goal and a set of requirements for the crowdsourcing project. These requirements may be associated with cost, deadlines, number of people involved, minimum skillsets required, outcome quality indicators, etc. Any participant 20′ in the crowd can look at the collaboration patterns available to solve that project and, if deemed necessary, propose a new collaboration pattern or modify an existing one, for example, using the collaboration pattern editor 134′.

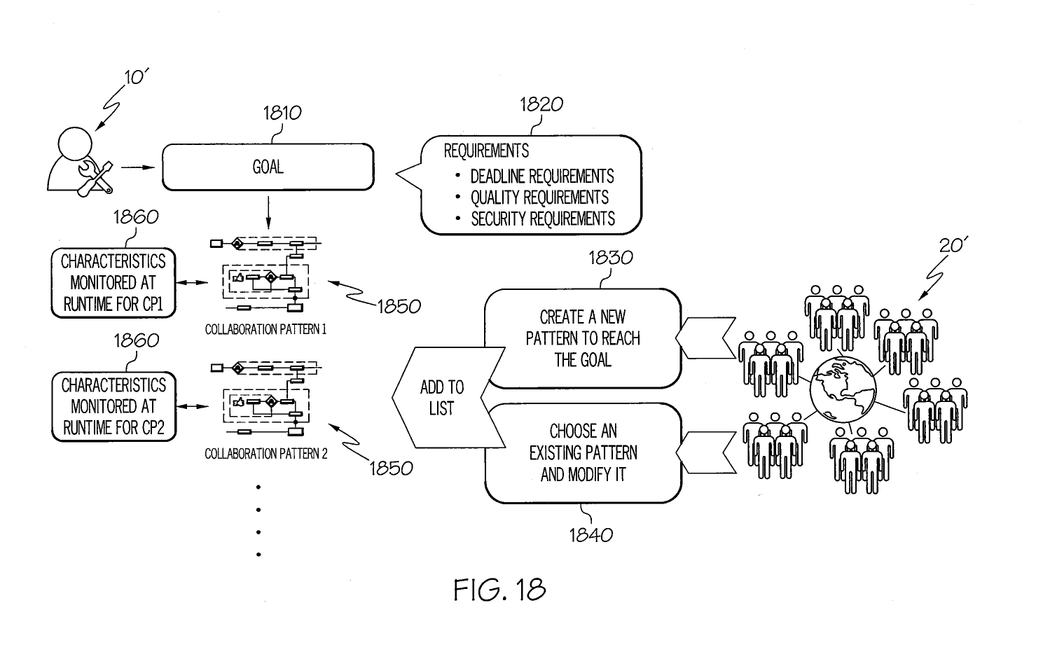

FIG. 18 provides another functional diagram of these embodiments. As illustrated in FIG. 18, a requestor 10′ can formulate a goal for a crowdsourcing project including requirements 1820, as was described for example in connection with Block 1110 of FIG. 11, using the requirements generator 132′. The requirements are published as was described in connection with Block 1110. Based on these requirements, crowdsourcing participants 20′ may create candidate collaboration patterns, as was described at Block 1120 of FIG. 11. As was described in connection with Block 1120, the candidate collaboration patterns can include a new collaboration pattern 1830 that is not based on a collaboration pattern in a collaboration pattern library 136′ or can include a modification 1840 of a collaboration pattern that is in a collaboration pattern library 136′. Thus, participants may choose one of the existing collaboration patterns and modify them through the editor 134′, as shown at 1840. These collaboration patterns are added to the list of patterns and one of the collaboration patterns 1850 is then selected, as was described in connection with Block 1130. A new requestor posting a goal that was solved in the past (or a similar one that can be solved in a similar way) can also select one of the existing collaboration patterns as a candidate pattern. Post processing described at Blocks 1150 and 1410 may be used to monitor-characteristics for the selected pattern as shown at Block 1860 in FIG. 18.

As was also described at Block 1420, participants may be also rewarded for contributing new collaboration patterns and/or when these collaboration patterns are used. Rewards may be economic (for example, paying a fixed fee to the creator of a workflow each time it is used) and/or based on other interests of workers such as reputation, etc.

As was also described in connection with Block 1420, as collaboration patterns are used, various embodiments described herein can collect statistics and create a collaboration pattern profile, including information about different relevant aspects such as time of execution of the process, number of people required, cost to execute that process (for example, if incentive rewards are offered to workers), quality, etc. Various embodiments described herein may also collect worker satisfaction after performing a specific task and requestor satisfaction (which may be another indicator for quality). As one example, in Crowdscape: Interactively Visualizing User Behavior And Output (Rzeszotarski et al., Proceedings of the 25th annual ACM symposium on User interface software and technology (UIST '12). ACM, New York, N.Y., USA, 55-62 (2012)), the authors present CrowdScape, a system that supports the human evaluation of complex crowd work through interactive visualization and mixed initiative machine learning, unifying different quality-control mechanisms in crowdsourcing platforms. They provide tools to better understand worker behavior and tools to group and classify them. As an example, various embodiments of Block 1410 may collect information from a system like CrowdScape.

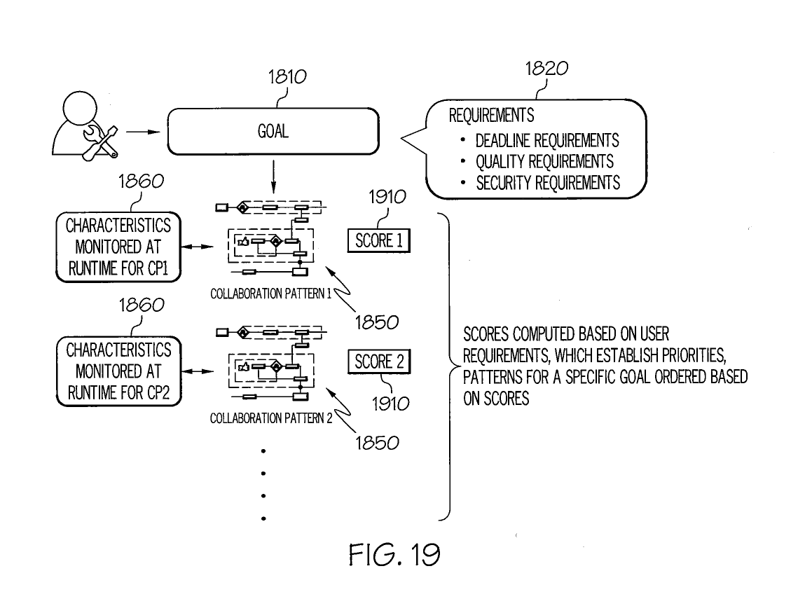

As was also described in connection with Block 1130 and FIG. 13, based on the characteristics of a collaboration pattern and the requirements defined by the requestor, a score can be computed for each existing collaboration pattern. For example, as illustrated in FIG. 19, and as was described in connection with Block 1320, using those scores 1910, collaboration patterns can be ordered or ranked based on the requestor requirements, the past behavior and statistics, and the opinion of previous users.

FIG. 20 is a flowchart of preprocessing operations that may be performed according to various embodiments described herein. These preprocessing operations 2000 may be performed in order to decide whether to publish the requirements for the crowdsourcing project to the crowdsourcing participants of Block 1110. Stated differently, in some embodiments, these preprocessing operations may be performed prior to, and/or as part of, the operations of Block 1110. These preprocessing operations of FIG. 20 can provide embodiments wherein the publishing is preceded by accessing a collaboration pattern that is related to the crowdsourcing task, and the publishing comprises publishing the collaboration pattern that is related to the crowdsourcing task along with the requirements for the crowdsourcing project. In other embodiments, the collaboration patterns that were used for the same or similar tasks may always be available in the collaboration pattern library, so that they need not be published along with the requirements for the crowdsourcing project.

Referring to FIG. 20, at Block 2010 a new crowdsourcing project is opened. Specifically, a requestor who wants to open a new call for a new crowdsourcing project may look for preexisting tasks in a database, such as the collaboration pattern library 136′, to see if that task was solved previously. In order to do so, the system can provide a search engine to look for tasks. Search methods may include analysis of the goal's textual description using simple exact keyword searches and/or more sophisticated mechanisms to allow for searching semantically related patterns (for example, based in ontologies, considering non-exact matches, etc).

At Block 2020, if a similar task is found, then at Block 2030 the system will retrieve all the collaboration patterns (workflows) related to that task, which may be ordered or ranked depending on the score that was computed based on the requirements expressed by the requestor. If a similar task is not found in the database at Block 2020, the project can be published at Block 1110 and the system can wait for the crowd to propose a new collaboration pattern for it. Moreover, even if a similar task was found at Block 2020, the requestor may chose to publish the requirements and the related task that was found, at Block 2040. The participants may then further refine the collaboration patterns or propose new collaboration patterns based on the collaboration patterns that were found at Block 2030. In other embodiments, the collaboration patterns that were used for the same or similar tasks may always be available in the collaboration pattern library, so that they need not be published along with the requirements for the crowdsourcing project.

Finally, as was described above in connection with Block 1310, when a new collaboration pattern is proposed the system may not have information about its performance. However, the collaboration pattern may be shown for that project even if information about performance is not available. This may always happen when the first collaboration pattern is proposed for a task. It may also happen when a new collaboration pattern is proposed for a task for which other collaboration patterns have already been proposed. In these cases, it may be difficult to encourage requestors to use the new, non-evaluated, collaboration pattern. However, as was described above, various embodiments described herein may allow creating a new collaboration pattern as an improvement of a previously existing collaboration pattern. Linking a new collaboration pattern to an existing one can also allow the designer of the collaboration pattern to explain the motivation to create this new collaboration pattern. The designer may want to remark what characteristics of the previous collaboration pattern are improved. When a request accesses a collaboration pattern, the potential improvement to collaboration patterns associated to this one may be shown. In this way, a new collaboration pattern can be accessed through an already established collaboration pattern for that collaborative project.

Accordingly, various embodiments described herein can create complex collaborative patterns to coordinate workers in a crowdsourcing environment in an unsupervised way. The system may be used to provide potential good collaboration patterns for future tasks, based on a multidimensional analysis of those patterns.

### EXAMPLE

The following Example shall be regarded as merely illustrative and shall not be construed as limiting the invention. This is an end-to-end Example that takes place after the initial startup of the platform 130′. Initially the collaboration pattern library 136′ is empty.

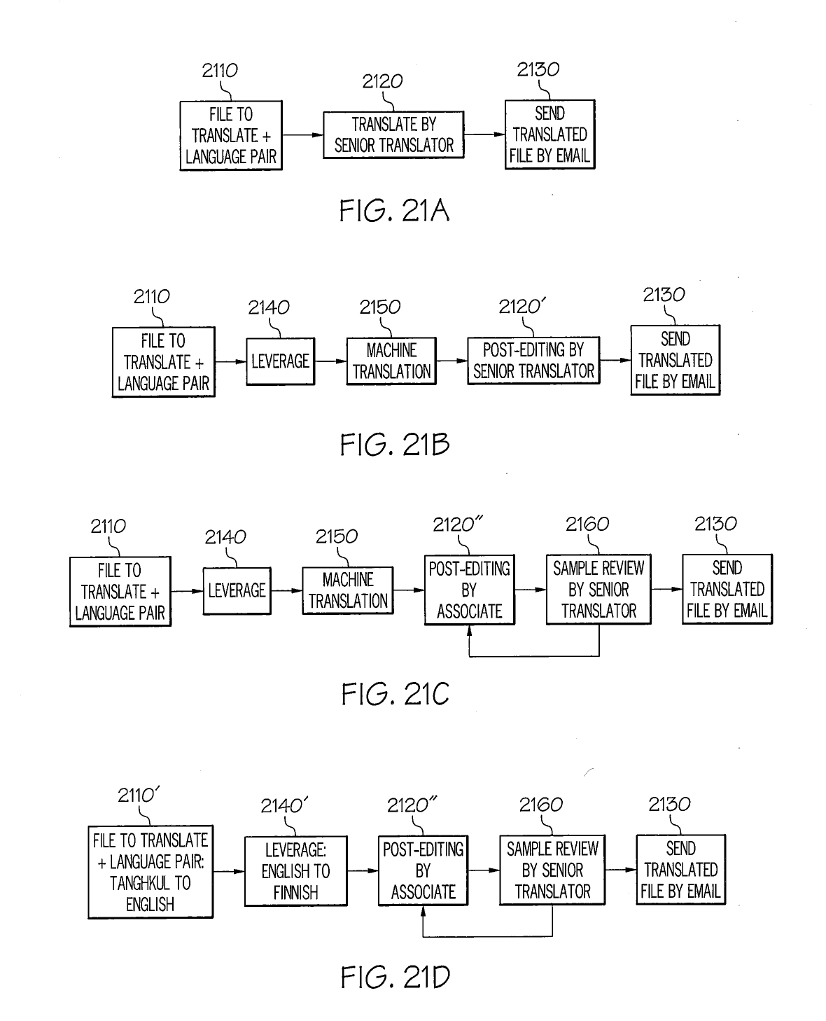

In this Example, an organization becomes aware of the existence of the crowdsourcing platform 130′ and decides to use it to translate text they have in some files. The person in charge of localization in the organization (the “requestor” 10′) then registers into the platform 130′ and sees that there is no collaboration pattern available for that task at this moment. Thus, the requestor 10′ decides to create one with the collaboration pattern editor 134′. The pattern the requestor 10′ creates is illustrated in FIG. 21A.

The collaboration pattern of FIG. 21A includes three tasks. In the first task of Block 2110, the file to translate and the language pair, i.e., the source and target languages of the translation, are gathered. This is a task that the requestor 10′ defines as always available, so that allowed crowdsourcing participants 20′ can always perform it. The requestor 10′ decides that the group of allowed participants 20′ will be only the personal of the localization department in the requestor's organization. The requestor 10′ may note that the requestor 10′ needs to ask the people on her department to enroll in the platform, so that the requestor 10′ can form a group with their usernames and specify that group name in the collaboration pattern editor 134′.

The second task in the pattern (Block 2120) is a translation task for that language pair and the given file. The requestor 10′ may limit the allowed participants to users having a particular set of skills. Specifically, the platform 130′ may assign skills to users, as well as several metrics to each (user, skill) combination, such as experience (how much work this user has done in tasks requiring that skill), ranking (how well did the user perform on those tasks), etc. In this case, the requestor 10′ indicates that the participant should have experience and have a good ranking for the translation skill of that particular language pair (denoted as “Senior translator” in Block 2120). Note that the tasks of Blocks 2110 and 2120 are human implemented tasks.

Finally, there is an automated task (not involving humans) at Block 2130, that will send the translated file generated in the second task through email to the worker that completed the first task (Block 2110).

Once the requestor 10′ completes the design of the collaboration pattern of FIG. 21A and is satisfied with it, the requestor can send it to the execution engine 138′. That will make available the first task 2110 to the people in the requestor's department, so whenever there is the need to translate a document, they will connect to the platform 130′, select that task 2110, provide the language pair and the file to translate and submit the task 2110. This will create a translation task available to senior translators of that language pair.

For the sake of simplicity, assume that there are participants with the required skills already registered in the platform 130. Whenever they complete the translation task 2120 and the pattern completes, the system gathers information on the time each task 2120 was awaiting a participant to claim it, the completion time of each task 2120 and the whole pattern, participant satisfaction (for instance this could be a 1-5 like scale that a participant must fill in each time/the first time/from time to time when the participant submits a task).

This information is gathered and is used to create several scores for the pattern of FIG. 21A, for instance, participant satisfaction and average execution time. In terms of quality, in this case no information is available as there is no automated/human review of the output. Structural qualities, such as the resilience to fraud can also be considered. In this case, the fact that the first task 2110 is performed by trusted workers and the second task 2120 is performed by experienced and quality workers is a positive asset, while the fact that there is no verification task for the second task 2120 is a negative one.

Consider now that, after a while, a bigger organization with similar needs also registers in the platform 130′. The new requestor 20′ for this bigger organization looks for patterns related to translation and finds the one in FIG. 21A. The new requestor 20′ looks at the statistics of the pattern and thinks that the process is too slow and expensive because translators have to translate from scratch.

Consequently, the new requestor 20′ decides to create a modification of the previous collaboration pattern as illustrated in FIG. 21B. In this variant, an automated preprocessing task 2140 is added that tries to reuse as much text as possible from previous translations (“leverage”). Another automated preprocessing task 2150 makes use of machine translation in the text fragments that could not be leveraged. Since this is a bigger organization it has the infrastructure to perform these automated tasks. Post-editing 2120′ may then be performed by a senior translator.

As this example illustrates, patterns might also have a set of requirements in order to be executed that will be specified by the creator of the pattern. Patterns can also be searched in the library 136′ considering these requirements as search filters.

The requestor 20′ of the pattern of FIG. 21B can recommend this version. Specifically, patterns can have a text associated written by their creator, which describes their advantages. In this case, an advantage may be reduced cost, since post-editing 2120′ may be less costly than direct translation 2120, although it may require additional infrastructure, such as tools to perform the leverage 2140 and the machine translation 2150 parts that the new user specifies as a requirement of the pattern.

Accordingly, FIGS. 21A and 21B illustrate two patterns for the same task but with different properties: the first one (FIG. 21A) is the simpler pattern, thus the one requiring less infrastructure, and the second one (FIG. 21B) is the cheapest and likely the fastest one.

Assume that the platform 130′ is using a “pay per use” reward, so that pattern requestors 10′ get some reward every time one of their proposed patterns is executed. Other reward methods may be conditioned to the efficiency in the execution of a particular pattern, so that the creator is only rewarded if some minimal conditions in the results of execution a particular pattern are met.

Created patterns may be stored, by default, to a public library 136′ where other users 10′ of the platform 130′ can browse existing collaboration patterns. However, the creator of the pattern can also specify that a particular pattern is private, and potentially may be charged for that, as in some business models like github. In that case, the pattern will not be stored in the library 136′ and only the creator will be able to edit it and send it to execution.

Now consider that a third requestor 10′ uses the platform. For example, the third requestor may be a worker that participated in some of the previous translation patterns, or simply some person with experience in the localization industry that has recently joined the platform. This third requestor thinks that the cost can be reduced because senior translators are expensive, and produces a new pattern variation that is shown in FIG. 21C.

The idea behind the pattern of FIG. 21C is that the post-editing may be performed by a less qualified (hence less paid) translator (Block 2120″), and the senior translator will only review a sample of the translated text (Block 2160), returning the text to the associate (Block 2120″) in case the review contains too many errors. The billing model (what will be paid to each individual participating, not shown in FIG. 21C) of this pattern can guarantee a cheaper price than the previous pattern (FIG. 21B). However there is a trade-off, since just performing a sampling review will likely produce a lower quality output than before. Also, the fact that now two workers must participate and there is a potential loop in the pattern will also likely increase the total time to get the final translation.

Note that the pattern of FIG. 21C can also be more resistant to some types of fraud than the previous ones. Specifically, the fact that there are now two workers (Blocks 2120″ and 2160) may make it more difficult for a greedy user to produce poor quality work without being noticed or affecting the quality. Thus, if the senior translator does not review at Block 2160 but the associate is still doing a good job at Block 2120″, quality would be better than having the same senior doing an unsupervised translation or post-editing.

When this new pattern of FIG. 21C is added into the library 136′, structural properties (like fraud resilience) may be computed. Metrics computed from executions will need to wait until some executions are completed. However, creators might indicate expected properties. In order to promote new patterns, they will be presented to requestors 10′ if they match the search criteria, either by real executions or by expected properties. For example, requestors could “vote” on expected properties, so that if a proposal by a creator has a set of claimed properties that are clearly not true, users can mark a pattern as dubious. In some cases, a pattern can be in three states depending on the associated information it has:
Structural information (e.g., fraud likeliness)+expected properties claimed by the creator (e.g., “cheaper than”, “faster than”, etc.), when the pattern has just been created, never examined by a requestor and never executed;
Structural information+expected properties claimed by the creator+requestor feedback (e.g., “can never be faster”), when the pattern has been created and already examined by some requestors; or
Structural information+execution metrics when the pattern has been executed. Note that the platform could wait to move to this stage until a reasonable number of executions is available.
   Note that in some cases, structural information can already prove or disprove some of the expected properties claims. For instance, depending on the billing model of the pattern, one can prove that a pattern will be cheaper than another. Alternatively, depending on the number of sequential steps that involve humans and how many workers with the required skills are available, a rough approximation of the completion time can be computed.

Assume there is yet another organization that wants to translate texts. They look into the library 136′ and sort the patterns by cost. Assume that from the previous patterns presented, the first two (FIGS. 21A and 21B) already have execution metrics, showing that the second (FIG. 21B) is actually cheaper than the first (FIG. 21A), while the third (FIG. 21C) has only the expected property of being cheaper than the second one.

This organization decides to use the latter (FIG. 21C) to translate between two minority languages (e.g., from Tangkhul to Finnish). However, after they start the execution they realize that it is difficult to progress in the execution of the pattern since the probability of a worker speaking both languages is very small.

Since they do not feel confident enough to design their own collaboration pattern, they decide to publish or post an open call so that the crowd proposes patterns for that type of task. The open call includes requirements that specify the objective of the pattern, the deadline (if any) to propose new patterns, and the rewards (if any) to the selected pattern. The selection process might be by direct inspection of all the candidates, but can also be done after some pre-selected patterns are executed a few times and then the requester selects based on the results of those executions.

In this example, assume that the requestor 20′ received several proposals, from which the requestor 20′ selected two of them that were executed. From these two alternative patterns, the one that had best performance is illustrated in FIG. 21D. This pattern contains more steps involving human intervention but produced a faster output than their initial pattern. In FIG. 21D, the Block 2110′ indicates Tangkhul to English translation. The leverage of Block 2140′ indicates English to Finnish translation.

Note that in this pattern the participant removed many of the non-human steps because the automation support for those languages might be lacking. Leverage software does not depend on the language pair to be applied, so it can be kept. Although now there are three humans involved (Blocks 2140′, 2120″ and 2160), the fact that the pattern uses a widely spoken language as an intermediate language helps in finding workers suitable for the proposed tasks.

The flowchart and block diagrams in the figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method comprising:
publishing requirements for a crowdsourcing project that comprises a crowdsourcing task, to crowdsourcing participants;
receiving candidate collaboration patterns for the crowdsourcing task from ones of the crowdsourcing participants;
selecting one of the candidate collaboration patterns; and
executing the crowdsourcing project using the one of the candidate collaboration patterns to perform the crowdsourcing task.

2. The method according to claim 1 wherein the publishing and the selecting are performed by a collaboration pattern co-creation system in response to input from a requestor of the crowdsourcing project, wherein the receiving is performed by a collaboration pattern editor and wherein the executing is performed by a collaboration pattern execution engine.

3. The method according to claim 1 wherein the requirements for the crowdsourcing project do not identify a collaboration pattern.

4. The method according to claim 1 wherein the receiving comprises receiving a candidate collaboration pattern for the crowdsourcing task as a selection from a library of collaboration patterns, as a modification of a collaboration pattern in the library or as a new collaboration pattern that is not based upon a collaboration pattern in the library.

5. The method according to claim 4 wherein the receiving comprises providing access by the crowdsourcing participants to the library of collaboration patterns.

6. The method according to claim 1 wherein the receiving is repeatedly performed prior to performing the selecting.

7. The method according to claim 1 further comprising:
generating effectiveness metrics for the one of the candidate collaboration patterns based on results of the executing the crowdsourcing project using the one of the candidate collaboration patterns.

8. The method according to claim 1 further comprising:
rewarding a crowdsourcing participant from whom the one of the candidate collaboration patterns was received.

9. The method according to claim 1 wherein the selecting comprises:
generating effectiveness metrics for the candidate collaboration patterns.

10. The method according to claim 9 wherein the generating effectiveness metrics comprises:
generating results profiles for the candidate collaboration patterns;
generating scores from the results profiles; and
ranking the candidate collaboration patterns according to the scores.

11. The method according to claim 10 wherein the generating results profiles for the candidate collaboration patterns comprises using a results profile from another crowdsourcing project that comprises the candidate collaboration pattern.

12. The method according to claim 1 further comprising:
informing the crowdsourcing participants of the one of the candidate collaboration patterns that was selected.

13. The method according to claim 1 wherein the publishing requirements is preceded by:
identifying a collaboration pattern that is related to the crowdsourcing task; and
wherein the publishing requirements comprises publishing the collaboration pattern that is related to the crowdsourcing project along with the requirements for the crowdsourcing project.

14. The method according to claim 1 wherein the candidate collaboration patterns comprise workflows to be followed to carry out the crowdsourcing task of the crowdsourcing project.

15. A computer program product comprising:
a computer readable storage medium having computer readable program code embodied in the medium, that when executed by a processor of a computer system, causes the computer system to perform operations comprising:
publishing requirements for a crowdsourcing project that comprise a crowdsourcing task, to crowdsourcing participants;
receiving candidate collaboration patterns for the crowdsourcing task from ones of the crowdsourcing participants;
selecting one of the candidate collaboration patterns; and
executing the crowdsourcing project using the one of the candidate collaboration patterns to perform the crowdsourcing task.

16. The computer program product according to claim 15 wherein the selecting comprises:
generating effectiveness metrics for the candidate collaboration patterns.

17. The computer program product according to claim 16 wherein the generating effectiveness metrics comprises:
generating results profiles for the candidate collaboration patterns;
generating scores from the results profiles; and
ranking the candidate collaboration patterns according to the scores.

18. The computer program product according to claim 17 wherein the generating results profiles for the candidate collaboration patterns comprises using a results profile from another crowdsourcing project that comprises the candidate collaboration pattern.

19. The computer program product according to claim 15 wherein the publishing requirements is preceded by:
identifying a collaboration pattern that is related to the crowdsourcing task; and
wherein the publishing requirements comprises publishing the crowdsourcing task that is related to the crowdsourcing project along with the requirements for the crowdsourcing project.

20. A computer system comprising:
a processor; and
a memory coupled to the processor, the memory comprising computer readable program code embodied therein that, when executed by the processor, causes the processor to perform operations comprising:
publishing requirements for a crowdsourcing project that comprises a crowdsourcing task, to crowdsourcing participants;
receiving candidate collaboration patterns for the crowdsourcing task from ones of the crowdsourcing participants;
selecting one of the candidate collaboration patterns; and
executing the crowdsourcing project using the one of the candidate collaboration patterns to perform the crowdsourcing task.
